(19) United States
(12) Patent Application Publication
(10) Pub. No.: US 2022/0389233 A1
(43) Pub. Date: Dec. 8, 2022

(54) SELF-CLEANING, ANTI-SOILING COATINGS WITH ADDITIONAL FUNCTIONALITIES AND METHOD OF PRODUCTION THEREOF

(71) Applicant: Hanna BENMOSHE, Tel Aviv (IL)

(72) Inventors: Hanna BENMOSHE, Tel Aviv (IL); Sven RÜHLE, Tel Aviv (IL)

(21) Appl. No.: 17/774,133

(22) PCT Filed: Nov. 4, 2020
(86) PCT No.: PCT/IL2020/051148

§ 371 Date: May 3, 2022

Related U.S. Application Data
(60) Provisional application No. 62/930,223, filed on Nov. 4, 2019.

(51) Int. Cl. C09D 5/00; B08B 17/06; C09D 7/40; C09D 1/00

(52) U.S. Cl. CPC C09D 5/00; B08B 17/06; C09D 7/67; C09D 1/00; C03C 17/256

(57) ABSTRACT

Mesoporous nanostructured coatings are disclosed. The coatings comprise particles of a refractory material, the particles having diameters <200 nm, connected by a material that is formed from a precursor that is deposited on the substrate with the particles, typically by oxidation of the precursor. The material that connects the particles enhances their necking and adhesion to the substrate. In preferred embodiments, the coatings are multi-functional, combining anti-reflective properties with a second property such as self-cleaning or anti-soiling. A novel method for making the coatings, based on inkjet technology, is also disclosed.

### FIELD OF THE INVENTION

This invention relates in general to protective coatings for glass surfaces. It relates more specifically to multi-functional self-cleaning, anti-soiling coatings that include additional functionalities such as anti-reflection or low emissivity for glass surfaces.

### BACKGROUND OF THE INVENTION

Self-cleaning properties are of great interest for glass windows in buildings, especially in high rise towers where cleaning from the outside cannot be done easily. Furthermore, self-cleaning and anti-soiling properties are of paramount importance for flat glass used in photovoltaic (PV) modules, due to the energy loss associated with a reduced window transmittance caused by dirt and dust accumulation.

Depending on the application additional properties are often required besides self-cleaning. In PV the coating should have anti-reflective (AR) properties in order to maximize the energy throughput through the glass while for building or transportation applications a reduced transmittance might be desired.

The requirements for self-cleaning coatings are very high and the self-cleaning property has to last as long as the lifetime of the product, which is two to three decades for PV modules and significantly more for buildings. Furthermore, the self-cleaning requirements can vary depending on the climate—in dry desert areas, anti-soiling coatings that operate under dry conditions might be preferred over hydrophilic or hydrophobic coatings from which dirt is removed with the help of water. The latter are a good solution for areas with regular rainfall.

Self-cleaning coatings are often characterized by the hydrophobicity or hydrophilicity of the surface and are categorized by the contact angle of a water droplet on the surface. In general, the term “hydrophilic” refers to a surface on which a water droplet has a contact angle of less than 90°, while the term “hydrophobic” refers to a surface on which a water droplet has a contact angle of greater than 90°. Hydrophobic surfaces on which the contact angle is of 150° and above are known in the art as “ultra-hydrophobic”; these surfaces are also sometimes termed “super-hydrophobic.” The self-cleaning effect of hydrophillic coatings is caused by water droplets that spread on the coating, forming a thin water film on the surface that removes contamination. The self-cleaning effect of ultrahydrophobic coatings is based on water droplets that are easily sliding off the surface and take contamination with them. In both cases water is needed to achieve the self-cleaning effect.

Examples of super-hydrophobic self-cleaning coatings are described in a review article by V. Anand Ganesh et al. (Anand Ganesh, V; Kumar Raut, H.; Sreekumaran Nair, A.; Ramakrishna, S. J. Mater. Chem. 2011, 21, 16304-16322).

A further effect that can be used to achieve self-cleaning surfaces is the photocatalytic oxidation of organic material. The most prominent example is TiO₂, which is absorbing UV light to generate electron-hole pairs. At the TiO₂ surface the holes oxidize organic material such as bird dropping or fallen leaves and thus accelerate the chemical dissociation of the contamination. Furthermore, TiO₂ is hydrophilic and provides good wetting to rinse off the contamination. Commercial glass, covered with a self-cleaning coating is for example offered by Pilkington Group Ltd and marketed under the trade name PILKINGTON ACTIV.

Surface contamination with inorganic material like dust and soil is a problem for photovoltaic modules, particularly in areas with dry and desert like climate. Self-cleaning and anti-soiling effects need to be achieved by a coating that can operate in the absence of water.

Most photovoltaic windows known in the art are covered with an AR coating that lacks special self-cleaning properties, thus requiring special cleaning solutions. Building windows require periodic cleaning, which today is still done manually or by cleaning robots. The challenge to find coating materials that combine two or more properties such as AR and self-cleaning without loss in long term stability of the coating is an ongoing research topic. No coating that fulfills all of these requirements is currently on the market, however.

Nanotechnology opens the door to create different functionalities of a single coating layer. The properties of a surface coating are not only determined by the chemical composition of the coating material but also by its morphology, i.e. its porosity and surface texture. With the advancement of nanotechnology these properties can be individually tailored for the desired application.

The self-cleaning effect is determined by the hydrophobic or hydrophilic character of the surface, which is determined by the type of material used as well as the surface texture. Ultra-hydrophobic surfaces are achieved when a micro- to nano-structured surface texture is used similar to the lotus leave.

To achieve AR properties, the refractive index n of the coating should be larger than that of air (nₐᵢᵣ≈1) and smaller than the index of the substrate material, e.g. glass (n_{glass}≈1.5).

Anti-reflectivity is either achieved by use of a bulk material characterized by a refractive index between nₐᵢᵣ and n_{glass}, for example, MgF₂, which has n=1.28, or by using a mesoporous film where the pore and particle size is significantly smaller than the wavelength of light. In such films the refractive index corresponds to the volume fraction of the porous material. In such way AR films can also be produced from materials with an unfavorable refractive index of its bulk material.

A number of anti-reflective coatings for smooth surfaces such as glass that are based on nanotechnology are known in the art. For example, PCT (International) Pat. Appl. Pub. No. WO2004/042434 discloses a mechanically durable single layer AR coating comprising a structured surface, preferably a nano-structured surface. The coating is prepared by applying a mixture of a material that will crosslink under the reaction conditions, a material that will not crosslink under the reaction conditions, and nanoparticles; inducing crosslinking; and then removing at least part of the material that does not crosslink.

PCT Pat. Appl. Pub. No. WO2004/104113 discloses process for preparing a nano-structured surface coating and articles comprising the coating. The process comprises applying a mixture of reactive nanoparticles, at least one solvent, and optionally a compound having at least one polymerizable group; and inducing crosslinking and/or polymerization in the mixture.

U.S. Pat. Appl. Pub. No. 2008/0171192 discloses an AR coating in the form of at least one layer of equally-spaced nanoparticles made from a material that under incident light generates between neighboring particles an optical resonance with a frequency in the visible range. The nanoparticles have a radius of 10-100 nm and a pitch between adjacent particles that ranges from 1.5 diameters to several diameters.

PCT Appl. Pub. No. 2011/157820 discloses an inorganic oxide coating comprising an inorganic oxide precursor based on at least one element selected from the group consisting of aluminum, silicon, titanium, zirconium, niobium, indium, tin, antimony, tantalum, and bismuth; and a second inorganic oxide precursor based on at least one element selected from the group consisting of the Group 3 metals and lanthanides. A method of preparing the coating is also disclosed.

U.S. Pat. No. 9,353,268 discloses an abrasion resistant, anti-soiling AR coating for glass. The coating materials are formed from hydrolyzed silane-based precursors through a sol-gel process.

U.S. Pat. Appl. Pub. No. 2020/0238797 discloses a nano-structured AR coating for architectural or automotive glass that includes pores that increase in size from a base layer at the surface of the glass substrate to the porous surface of the coating. The coating comprises silica-based structures and sodium borate portions.

Despite the massive effort that has been devoted to development of coatings based on nanotechnology, an improved nanotechnology-based coating that combines self-cleaning or anti-soiling properties with additional functionalities such as anti-reflection or low emissivity and an improved method for making such coatings remains a long-sought, but as yet unmet need.

### SUMMARY OF THE INVENTION

The invention disclosed herein is designed to meet this need. The present invention discloses a method of fabricating durable, low-cost coatings with two or more functionalities, such as self-cleaning, anti-soiling, photo-catalytic, low emissivity, and AR. In preferred embodiments of the invention, the coatings are produced by depositing a coating liquid on a substrate by using techniques of inkjet printing; other non-vacuum techniques such as spraying, dip-coating, doctor blade, screen printing, Mayer rod, and forming rod coating can be used as well. A superior anti-reflective effect is achieved with a surface of graded refractive index. A good approximation of graded refractive index can be produced with the nano-structured coating described herein. The inkjet technique has several advantages over other techniques known in the art. It is able to cover large areas with a layer having a very well-defined thickness and structure within a short time; it can be used for deposition of a single material in a compact layer; in contrast to other techniques such as blade, dip, or spray coating, it can produce a two-dimensional patterned layer with partial surface coverages; and it can be used to deposit two or more different materials onto a single substrate to created a complex two-dimensional pattern for a multi-functional coating. The present invention also discloses novel coatings that can be made by the inventive method.

It is therefore an object of the present invention to disclose a mesoporous nanostructured coating, comprising: (a) at least one layer of particles of at least one refractory material; and, (b) at least one second material, wherein at least a portion of said particles are bound or interconnected one to another by said second material; and further wherein said second material is a product of a reaction of a precursor material, said reaction occurring with or subsequent to deposition of said particles. In some preferred embodiments of the invention, said particles are selected from the group consisting of microparticles, sub-micron particles, and nanoparticles. In some preferred embodiments of the invention, the particles are characterized by diameters of <200 nm.

It is a further object of this invention to disclose the mesoporous nanostructured coating as defined in any of the above, wherein said refractory material is selected from the group consisting of SiO₂, TiO₂, SnO₂, F:SnO₂, Sb:SnO₂, ZrO₂, Al₂O₃, NiO, Ag, Au, Mg, Ti, Al, Mn, and combinations thereof.

It is a further object of this invention to disclose the mesoporous nanostructured coating as defined in any of the above, wherein said precursor material is selected from the group consisting of metasilicate salts, borate salts, Mg(OAc)₂, Ni(NO₃)₃, and combinations thereof. In some preferred embodiments of the invention, said metasilicate salt is Na₂SiO₃. In some preferred embodiments of the invention, said borate salt is Na₂B₄O₇.

It is a further object of this invention to disclose the mesoporous nanostructured coating as defined in any of the above, wherein said coating is at least 60% SiO₂ by volume of solid material, excluding pores.

The mesoporous nanostructured coating according to claim 1, wherein said coating is characterized by a porosity of 30-55%.

It is a further object of this invention to disclose the mesoporous nanostructured coating as defined in any of the above, wherein said coating comprises <0.1% by volume of organic material.

It is a further object of this invention to disclose the mesoporous nanostructured coating as defined in any of the above, wherein said coating comprises particles of a material that generates electron-hole pairs upon irradiation by visible or UV light interconnected with particles of an electron-accepting material.

It is a further object of this invention to disclose the mesoporous nanostructured coating as defined in any of the above, wherein said coating is made of a material that produces a positive surface charge upon irradiation by visible or UV light.

It is a further object of this invention to disclose the mesoporous nanostructured coating as defined in any of the above, wherein said coating is super-hydrophobic.

It is a further object of this invention to disclose the mesoporous nanostructured coating as defined in any of the above, wherein said coating is hydrophilic.

It is a further object of this invention to disclose the mesoporous nanostructured coating as defined in any of the above, wherein said coating comprises more than two components.

It is a further object of this invention to disclose the mesoporous nanostructured coating as defined in any of the above, wherein said coating is characterized by a single layer comprising a plurality of compositions, said compositions disposed according to a predetermined two-dimensional pattern in which said pattern comprises areas of different compositions. In some preferred embodiments of the invention, said predetermined two-dimensional pattern is selected from the group consisting of: a checkerboard pattern; and, lines of coating material separated one from another.

It is a further object of this invention to disclose the mesoporous nanostructured coating as defined in any of the above, wherein said coating comprises a plurality of layers of different compositions. In some preferred embodiments of the invention, at least one of the following is true: at least one of said layers comprises an electron-donating material; at least one of said layers comprises an electron-accepting material; at least one of said layers comprises a hole-accepting material; and, at least one of said layers comprises a material that produces electron-hole pairs upon irradiation by visible or UV light. In some preferred embodiments of the invention, said coating comprises a lower layer comprising particles of an electron-accepting material and an upper layer comprising particles of a hole-accepting material. In some preferred embodiments of the invention, said plurality of layers comprises a bottom layer in the form of lines of coating material separated from one another, and at least one additional layer in the form of lines of coating material separated from one another, each of said lines comprising each of said at least one additional layer lying atop a line of coating material of a layer below it.

It is a further object of this invention to disclose the mesoporous nanostructured coating as defined in any of the above, wherein said coating is characterized by a composition selected from the group consisting of:
(a) 70-74% SiO₂; (b) 5%-15% TiO₂; (c) 10% of a material selected from the group consisting of SnO₂, F:SnO₂, Sb:SnO₂, and combinations thereof; (d) 10% of a material selected from the group consisting of Al₂O₃, ZrO₂, and combinations thereof; (e) 1-5% of a material selected from the group consisting of Na₂SiO₃, MgO, Na₂B₄O₇, and combinations thereof; and, (f) ≤2% NiO;
a first layer comprising (a) 60-69% SiO₂; (b) 30-39% of a material selected from the group consisting of SnO₂, F:SnO₂, and combinations thereof; and, (c) 1-5% of a material selected from the group consisting of Na₂SiO₃, MgO, Na₂B₄O₇, and combinations thereof; and a second layer comprising (a) 60-69% SiO₂; (b) 5-15% TiO₂; (c) 10-30% of a material selected from the group consisting of ZrO₂ and Al₂O₃; (d) 1-5% of a material selected from the group consisting of Na₂SiO₃, MgO, Na₂B₄O₇, and combinations thereof; and, (e) ≤2% NiO; and,
(a) 70% SiO₂; (b) 5% TiO₂; (c) 3% Ag₂O₁₋ₓ (0.1≤x≤0.9); (d) 10% of a material selected from the group consisting of SnO₂, F:SnO₂, Sb:SnO₂, and combinations thereof; (e) 10% of a material selected from the group consisting of Al₂O₃, ZrO₂, and combinations thereof; and, (g) 2% of a material selected from the group consisting Na₂SiO₃, MgO, Na₂B₄O₇;

wherein all percentages are percent by volume of solid material, excluding voids.

It is a further object of this invention to disclose a method for preparing a mesoporous nanostructured coating on a substrate (1), wherein said method comprises: (a) preparing a coating liquid comprising a carrier liquid; and at least one material selected from the group consisting of particles of coating material, precursors of coating material, and dispersants; (b) depositing said coating liquid onto said substrate; (c) drying said coating liquid subsequent to said step of depositing; and, (d) heating said coating liquid subsequent to said step of depositing.

It is a further object of this invention to disclose such a method, wherein said carrier liquid is selected from the group consisting of water, methanol, ethanol, isopropanol, 1-propanol, 1-butanol, 2-butanol, isobutanol, tert-butanol, p-tert-octylphenoxypolyethoxyethyl alcohol, acetone, cyclohexane, toluene, butyl acetate, ethyl acetate, benzene, xylene, chloroform, diethyl ether, dichloromethane, dimethylformamide, acetonitrile, propylene carbonate, acetic acid, ammonia, formic acid, polyethylene glycol (PEG), polypropylene glycol, polyvinyl acetate, glycerine, and mixtures thereof.

It is a further object of this invention to disclose the method as defined in any of the above, wherein said step of preparing a coating liquid comprises preparing a coating liquid comprising a suspension and/or dispersion of at least one coating material selected from the group consisting of microparticles, sub-micron particles, and nanoparticles.

It is a further object of this invention to disclose the method as defined in any of the above, wherein said suspension and/or dispersion comprises particles of more than one material, and each material has a different particle size and/or distribution.

It is a further object of this invention to disclose the method as defined in any of the above, wherein said step of preparing a coating liquid comprises preparing a coating liquid comprising a suspension and/or dispersion of at least one coating material selected from the group consisting of SiO₂, TiO₂, ZrO₂, SnO₂, F:SnO₂, Sb:SnO₂, and Fe₂O₃.

It is a further object of this invention to disclose the method as defined in any of the above, wherein said step of preparing a coating liquid comprises preparing a coating liquid comprising a suspension and/or dispersion of at least one coating material selected from the group consisting of SiO₂, TiO₂, ZrO₂, SnO₂, F:SnO₂, Sb:SnO₂, and Fe₂O₃, and at least one material selected from the group consisting of Ag, Au, Mg, Ti, Al and Mn.

It is a further object of this invention to disclose the method as defined in any of the above, wherein said step of preparing a coating liquid comprises preparing a coating liquid comprising a coating material or precursor thereof that has photocatalytic activity.

It is a further object of this invention to disclose the method as defined in any of the above, wherein said step of preparing a coating liquid comprises preparing a coating liquid selected from the group consisting of:
a coating liquid comprising a suspension or dispersion comprising particles of SiO₂ and TiO₂ in a volume ratio SiO₂:TiO₂ of at least 95:5;
a coating liquid comprising a dissolved Ti-containing precursor and suspended or dispersed SiO₂ spheres, wherein said SiO₂ spheres are characterized diameters of 4-500 nm; and,
a coating liquid comprising particles of SiO₂ and Ag in a volume ratio SiO₂:Ag of at least 95:5.

It is a further object of this invention to disclose the method as defined in any of the above, wherein said step of preparing a coating liquid comprises preparing a coating liquid comprising: (a) particles of SiO₂; (b) particles of TiO₂; (c) particles of Ag; (d) particles of at least one substance selected from the group consisting of SnO₂, F:SnO₂, and Sb:SnO₂; (e) particles of at least one substance selected from the group consisting of Al₂O₃ and ZrO₂; and (f) at least one material in solution, said at least one material in solution selected from the group consisting of Na₂SiO₃, Na₂B₄O₇, Mg(OAc)₂, Ni(NO₃)₃, PEG, and TPE.

It is a further object of this invention to disclose the method as defined in any of the above, wherein said substrate is selected from the group consisting of glass, metal, ceramic materials, and stone.

It is a further object of this invention to disclose the method as defined in any of the above, wherein step of depositing said coating liquid on said substrate comprises:
introducing said coating liquid into a first print unit (23), said first print unit comprising least one print head (21), said print head comprising at least one printing nozzle (20);
placing said inkjet printer at a predetermined distance from said substrate;
moving said substrate (1) with a velocity vₓ relative to said at least one printing nozzle; and,
depositing droplets of said coating liquid in said first predetermined pattern and with a predetermined spacing from said at least one print head onto said substrate via said at least one printing nozzle.

In some preferred embodiments of the invention, said predetermined spacing is such that adjacent droplets partially overlap, thereby providing full surface coverage. In some predetermined embodiments of the invention, said predetermined spacing is greater than the average diameter of said droplets, thereby providing partial surface coverage.

In some preferred embodiments of the invention in which said step of depositing said coating liquid comprises a step of introducing said coating liquid into a first print unit, said first print unit comprises at least one additional print head (22) offset in a y direction from said at least one print head (21).

In some preferred embodiments of the invention in which said step of depositing said coating liquid comprises a step of introducing said coating liquid into a first print unit, said step of depositing said coating liquid on said substrate comprises: (a) depositing a first coating liquid on said substrate in a first predetermined pattern; (b) adding, for each additional coating liquid to be used, at least one additional print unit (31) comprising at least one additional print unit print head (30); (c) introducing at least one additional coating liquid into each said additional print unit print head; and, (d) depositing said at least one additional coating liquid onto said substrate in an additional predetermined pattern. In some especially preferred embodiments of the invention, said first predetermined pattern and said second predetermined pattern together form a checkerboard pattern.

It is a further object of this invention to disclose the method as defined in any of the above, wherein said step of depositing said coating liquid on said substrate comprises depositing multiple layers of coating liquid, one atop another. In some preferred embodiments of the invention, said step of depositing said coating liquid comprises drying each layer prior to deposition of a subsequent layer.

In some preferred embodiments of the invention in which said step of depositing said coating liquid comprises depositing multiple layers of coating liquid, said multiple layers comprise: a first layer (310) comprising transparent conductive electron-accepting material; a plurality of semiconductor layers (311, 312) comprising wide-band semiconductors, at least one of which absorbs light in at least a portion of the solar spectrum, deposited sequentially atop said first layer; and, a top layer (313) comprising transparent hole-accepting material, deposited atop said plurality of semiconductor layers.

In some preferred embodiments of the invention in which said step of depositing said coating liquid comprises depositing multiple layers of coating liquid:
said step of preparing a coating liquid comprises: (a) preparing a first coating liquid comprising particles of SiO₂; particles of at least one material selected from the group consisting of SnO₂, F:SnO₂, and Sb:SnO₂; at least one first material in solution selected from the group consisting of 1-20 mM Na₂SiO₃, 0.5-5 mM Na₂B₄O₇, 0.5-5 mM Mg(OAc)₂, and, at least one second material in solution selected from the group consisting of 0.1-10 mM PEG and 1-10 mM TPE; and, (b) preparing a second coating liquid comprising: particles of SiO₂; particles of TiO₂; at least one material selected from the group consisting of ZrO₂ and Al₂O₃; at least one third material in solution selected from the group consisting of 1-20 mM Na₂SiO₃, 0.5-5 mM Na₂B₄O₇, 0.5-5 mM Mg(OAc)₂, and, at least one fourth material in solution selected from the group consisting of 0.1-10 mM PEG and 1-10 mM TPE; and,
said step of depositing said coating liquid onto said substrate in a first predetermined pattern comprises: (a) depositing said first coating liquid on said substrate in a first predetermined pattern; (b) drying said first coating liquid; (c) depositing said second coating liquid on said substrate in a second predetermined pattern; and, (d) drying said second coating liquid.

In some preferred embodiments of the invention in which said step of depositing said coating liquid comprises depositing multiple layers of coating liquid:
said step of preparing a coating liquid comprises: (a) preparing a first coating liquid comprising: particles of SiO₂; particles of SnO₂; at least one first material in solution selected from the group consisting of 1-20 mM Na₂SiO₃, 0.5-5 mM Na₂B₄O₇, 0.5-5 mM Mg(OAc)₂, and, at least one second material in solution selected from the group consisting of 0.1-10 mM PEG and 1-10 mM TPE; and, (b) preparing a second coating liquid comprising: particles of SiO₂; particles of TiO₂; at least one third material in solution selected from the group consisting of 1-20 mM Na₂SiO₃, 0.5-5 mM Na₂B₄O₇, 0.5-5 mM Mg(OAc)₂, and, at least one fourth material in solution selected from the group consisting of 0.1-10 mM PEG and 1-10 mM TPE; and, (c) preparing a third coating liquid comprising: dispersed NiO particles; 1-50 mM dissolved Ni(NO₃)₂; and, at least one fifth material in solution selected from the group consisting of 0.1-10 mM PEG and 1-10 mM TPE; and,
said step of depositing said coating liquid onto said substrate in a first predetermined pattern comprises: (a) depositing onto said substrate a transparent conductive oxide (TCO) layer characterized by a sheet resistance <100 Ω/square; (b) depositing said first coating liquid onto said substrate, thereby forming a second layer; (c) drying said second layer; (d) depositing said second coating liquid onto said substrate, thereby forming a third layer; (e) drying said third layer; and, (f) depositing said third coating liquid onto said substrate, thereby forming a fourth layer.

In some preferred embodiments of the invention wherein said step of depositing said coating liquid comprises depositing a TCO layer, said step of depositing a TCO layer comprises a step selected from the group consisting of: (i) depositing a commercially-available TCO layer on said substrate; and, (ii) preparing a fourth coating liquid comprising (a) particles of SiO₂; (b) particles of doped SnO₂; (c) at least one sixth material in solution selected from the group consisting of 1-20 mM metasilicate salt, 0.5-5 mM borate salt, 0.5-5 mM Mg(OAc)₂; and (d) at least one seventh material in solution selected from the group consisting of 0.1-10 mM PEG and 1-10 mM TPE; and, depositing said fourth coating liquid onto said substrate, thereby forming a TCO layer.

In some preferred embodiments of the invention in which said step of depositing said coating liquid comprises depositing a plurality of n coating liquids on said substrate, said step of depositing said coating liquid comprises: (a) depositing each of said coating liquids so as to partially cover said substrate; (b) depositing each of said coating liquids 1 through n−1 such that each coating liquid is separated from each of the other coating liquids; and, (c) depositing coating liquid n so as to create an electrical connection between coating liquids 1 through n−1. In some especially preferred embodiments of the invention, each of said steps of depositing comprises depositing said coating liquid in the form of a line on said substrate.

It is a further object of this invention to disclose the method as defined in any of the above, wherein said step of drying comprises drying by a method selected from the group consisting of: (a) drying passively at ambient temperature in air; (b) drying passively at ambient temperature under an inert atmosphere; (c) blowing a gas over said coating material; (d) heating said coating material conductively by using a heater; (e) blowing a heated gas over said coating material; (f) drying radiatively by irradiating said coating material with IR, visible, UV, or x-ray radiation; and, (g) passing a vapor or gas comprising a reactive substance over said coating liquid, thereby inducing a chemical reaction in said coating liquid or between at least one component of said coating liquid and said reactive substance.

It is a further object of this invention to disclose the method as defined in any of the above, wherein said step of heating comprises heating said coating liquid until said particles of said coating material sinter to a predetermined degree.

It is a further object of this invention to disclose the method as defined in any of the above, wherein said step of heating comprises heating until said precursor undergoes a chemical reaction. In some preferred embodiments of the invention, said step of heating comprises heating until said precursor oxidizes and binds together particles of coating material.

It is a further object of this invention to disclose the method as defined in any of the above, wherein said step of heating comprises heating with a heating profile like that used to anneal glass.

It is a further object of this invention to disclose the method as defined in any of the above, wherein said step of heating comprises heating to a maximum temperature of between 630° C. and 680° C.

It is a further object of this invention to disclose the mesoporous nanostructured coating as defined in any of the above, produced by the method as defined in any of the above.

### BRIEF DESCRIPTION OF THE DRAWINGS

The invention will now be described with reference to the drawings, wherein:

FIG. 1 is a schematic drawing of a inkjet printer unit for the deposition of self-cleaning coatings onto flat surfaces, showing a top view and a side view;

FIG. 2 is a schematic drawing of a substrate partially covered with droplets deposited by an inkjet head;

FIGS. 3A-3D present schematic drawings of a top (FIG. 3A) and cross-sectional (FIG. 3B) views of a layered coating showing an example of four layers deposited on top of each other by inkjet printing onto a flat substrate material, and top (FIG. 3C) and cross-sectional (FIG. 3D) views of a layered coating in which the droplets have been printed in the y direction with sufficient overlap to form striped layers;

FIGS. 4A-4E present schematic drawings of a top view (FIG. 4A) of a coating consisting of three different type of pixels, shown with different hatchings; cross-sectional views of the different pixel types (FIG. 4B); a cross-sectional view of a pixel with combined properties (FIG. 4C); a cross-sectional view of another example of a pixel with combined properties that shows multi-layered structure to generate a surface charge (FIG. 4D); and a cross-sectional view of a coating with anti-reflection and photocatalytic or hydrophilic surface properties (FIG. 4E);

FIGS. 5A-5D present schematic drawings of cross-sectional views of a homogeneous mesoporous film deposited onto a substrate made from particles of a single material such as SiO₂ with a mono-dispersed particle size distribution (FIG. 5A); coating of a single material with a poly-disperse size distribution (FIG. 5B); a coating consisting of particles from two different materials but with similar size distributions (FIG. 5C); and a coating consisting of two different types of particles with polydisperse size distributions (FIG. 5D);

FIG. 6 presents transmittance spectra of an uncoated glass slide and a glass slide coated on one side according to the invention disclosed herein; and,

FIG. 7 presents photographs of an uncoated glass surface and a glass surface coated according to one embodiment of the invention disclosed herein.

### DETAILED DESCRIPTION OF THE PREFERRED EMBODIMENTS

In the following description, various aspects of the invention will be described. For the purposes of explanation, specific details are set forth in order to provide a thorough understanding of the invention. It will be apparent to one skilled in the art that there are other embodiments of the invention that differ in details without affecting the essential nature thereof. Therefore, the invention is not limited by that which is illustrated in the figures and described in the specification, but only as indicated in the accompanying claims, with the proper scope determined only by the broadest reasonable interpretation of said claims. In some cases, for clarity or conciseness, individual elements of the invention are discussed separately. Nonetheless, any combination of elements of the invention that are disclosed in the specification that is not self-contradictory is considered by the inventors to be within the scope of the invention.

As used herein, the abbreviation “AR” stands for “anti-reflective” or, if the context requires it, “anti-reflection.”

As used herein, the terms “coating liquid” and “ink” are used interchangeably to describe the liquid, which may contain materials in solution, suspension, or dispersion, that is to be deposited on a substrate and converted to the final coating. The term “ink” is used to emphasize that in preferred embodiments of the invention, the deposition of the liquid is performed by using inkjet printing technology, and does not imply the presence of any dye or pigment in the coating liquid.

As used herein, the terms “precursor material” and “precursor” are used to describe a component of the coating liquid that remains on the substrate as part of the final coating, but is converted during the process of production of the coating from its form in the coating liquid to a different form that it has in the final coating product. As a non-limiting example, a soluble silicate in the coating liquid that upon heating is converted to an oxide would be considered under this definition to be a “precursor” of the oxide.

As used herein, the term “borate salt” refers to any salt that includes an anion of the general formula (BₓO_{y})ⁿ⁻, x≥1, including hydrated forms.

As used herein, doping of one material with another is indicated in chemical formulas by a colon (:), wherein the dopant is listed to the left of the colon and the material into which the dopant is introduced is listed to the right of the colon. As a non-limiting example, “F:SnO₂” is used to indicate fluorine-doped tin(IV) oxide.

As used herein, the abbreviation “PEG” stands for “polyethylene glycol.”

As used herein, the abbreviation “TPE” stands for “triphenylethylene.”

In descriptions of size distributions, the expression “d_{N}” indicates that N % of the particles have a diameter of less than d.

As used herein, the expression “wt %” stands for “percent by weight.” In the case of dispersions or suspensions of insoluble solids, 1 wt %=1 g solid per 100 ml dispersion.

As used herein, with respect to numerical quantities, the term “about” refers to a range of ±20% of the nominal value.

In the description that follows, in cases in which the coatings of the instant invention and the method of making them are described as comprising “particles” of a substance, it is understood that the description is made without restriction to the size of the particles. It is further understood that when the word “particles” is used without explicit restriction of the particle size, particle diameters of on the order of μm, on the order of hundreds of nm, on the order of tens of nm, on the order of nm, and combinations thereof are all considered by the inventors to be within the scope of the invention.

### A. Novel Coatings

It is within the scope of this invention to disclose a family of novel coatings for smooth substrates such as glass, metal, ceramic materials, and stone. The coatings of the current invention comprise inorganic material that is chemically stable at temperatures up to 800° C., which is significantly above the softening temperature of glass. This thermal stability enables optimized heat treatment for best mechanical stability and adhesion. The coatings adopt their unique properties at least in part from the novel method by which they are produced. In contrast to similar coatings known in the art, the coatings of the invention disclosed herein contain <0.1% organic material. In preferred embodiments, the coatings do not contain any detectable amount of organic material.

The mesoporous coatings of the invention disclosed herein comprise particles distributed in at least one layer on a substrate along with at least partially material that binds or interconnects the particles to each other. In preferred embodiments of the invention, the particles are characterized by diameters of 2-200 nm. In yet other preferred embodiments of the invention, the particles are characterized by diameters of 80-150 nm. In some other preferred embodiments of the invention, the particles are characterized by diameters of 4-500 nm. In some preferred embodiments of the invention, the particle distribution is uniform (monodisperse). In other preferred embodiments of the invention, the particle distribution is nonuniform (polydisperse). In some preferred embodiments of the invention in which the particle distribution is nonuniform, it comprises particles of two or more different diameters that differ by at least 20 nm. In some other preferred embodiments of the invention in which the particle distribution is nonuniform, the particle distribution comprises particles characterized by a diameter of 2-30 nm and particles characterized by a diameter of 50-120 nm.

The material binding or interconnecting the particles is the product of a chemical reaction of a precursor material, the reaction taking place either simultaneously with or following deposition of the precursor material onto the substrate. In preferred embodiments, the precursor material has been deposited simultaneously with the particles, and the chemical reaction is oxidation that is activated by heating the substrate and/or the coating. The precursor thus acts as an inorganic “glue” that enhances the necking between adjacent particles as well as the adhesion of the particles to the substrate. In typical embodiments of the invention, the precursor is selected from the group consisting of metasilicate salts, borate salts, Mg(OAc)₂ (magnesium acetate), Ni(II) salts, and combinations thereof. In preferred embodiments, the precursor is selected from the group consisting of Na₂SiO₃, Na₂B₄O₇, Mg(OAc)₂, Ni(NO₃)₂, and combinations thereof.

The coatings can comprise particles of any suitable material. Non-limiting embodiments of materials from which the coating can be made include SiO₂, TiO₂, SnO₂, F:SnO₂, Sb:SnO₂, ZrO₂, Al₂O₃, NiO, Ag, Au, Mg, Ti, Al, Mn, and combinations thereof. In some preferred embodiments, the coating is at least 60% SiO₂ by volume (relative to the total solids, i.e. without reference to the pores). In some other preferred embodiments, the coating is at least 70% by volume. This large SiO₂ fraction enables the coatings to have strong AR properties while additionally providing other functions such as self-cleaning, anti-soiling, or photocatalytic abilities.

The mesoporous coatings of the invention disclosed herein have a porosity that typically ranges from 30-55%, as determined from optical spectra.

In some embodiments, the coatings comprise Al₂O₃, ZrO₂, or a mixture or combination thereof in order to improve their abrasion resistance.

In some embodiments, the coatings comprise a photocatalytic material (typically <5%) that can absorb UV light to generate electron-hole pairs. In preferred embodiments, the photocatalytic material comprises TiO₂. In these embodiments, the photocatalytic behavior of the added material (e.g. the TiO₂) provides the coating with self-cleaning properties, as the hole generated upon absorption of UV light oxidizes organic contaminants on the surface of the coating. The photocatalytic effect can be enhanced by interconnection of the particles of photocatalytic material with electron-accepting particles. Non-limiting examples of suitable electron-accepting materials include SnO₂ and doped SnO₂. At this interface, the electron-hole pairs are separated, leaving the hole in the photocatalytic particle, thereby reducing electron-hole recombination and enhancing the self-cleaning ability of the coating.

In some embodiments, the coating is anti-soiling. In preferred embodiments of the anti-soiling coatings, the surface of the coating has a positive surface charge or obtains a positive surface charge when irradiated by visible or UV light. In preferred embodiments, the anti-soiling effect is enhanced by introduction of a double-layer structure in which the layer close to the substrate contains a higher concentration of electron-accepting particles such as SnO₂ or doped SnO₂, while the outer layer contains hole-accepting particles such as TiO₂ or NiO.

TiO₂ is an example of a material with high photocatalytic activity that is only absorbs in a very limited portion of the solar spectrum that can be deposited by inkjet printing followed by a heat assisted pyrolysis step, described in detail below. Flat TiO₂ has a highly hydrophilic surface while nano-structured TiO₂ of the coatings disclosed herein can be prepared with a hydrophobic surface. The TiO₂ morphology is well controlled by the composition of the coating liquid deposited on the substrate to form the coating material, the substrate temperature, and further heat intake by radiation sources or by blowing hot gas above the substrate.

A detailed description of a method for producing the novel coatings, followed by a description of the properties of the pixels of the coatings in some preferred embodiments, are now presented in order to enable to a person of ordinary skill in the art to make and use the coatings of the invention disclosed herein.

### B. Method of Producing Coatings—General Description

The invention disclosed herein provides a method for producing self-cleaning coatings with additional functionalities. In preferred embodiments of the invention, the coatings are produced by using inkjet printing. Multi-functionality is achieved by the choice of the coating material (e.g. SiO₂, TiO₂, ZrO₂, SnO₂, F:SnO₂, etc.), the coating morphology (e.g. a compact layer with full density or a porous layer with a density lower than bulk density) and the surface texture (e.g. flat, nanostructured, micro-structured, etc.). All three parameters—material, morphology and surface texture—can be tuned individually and add different functionalities to the coating.

The method disclosed herein comprises four steps: preparing a coating liquid; depositing the coating liquid on a substrate; drying the coating liquid after its deposition on the substrate; and heating the dried coating liquid.

The chemical composition of the coating is defined by the composition of the coating liquid. The coating liquid comprises a carrier liquid and particles, preferably of a refractory material, suspended or dispersed in the carrier liquid. In preferred embodiments of the invention, the coating liquid additionally comprises precursor material dissolved in the carrier liquid, and optionally dispersant and/or a material such as PEG that improves the homogeneity of the coating. The precursor material is a material that is at least sparingly soluble in the carrier liquid and that can react during or after deposition on a substrate to form a substance, preferably an oxide, that will bind adjacent particles in the coating. In preferred embodiments, a chemical reaction takes place during the drying or heating process, e.g. an oxidation step, that yields the final chemical composition of the coating. In typical embodiments of the invention, the precursor is selected from the group consisting of metasilicates, borate salts, Mg(OAc)₂, Ni(II) salts, and combinations thereof. In preferred embodiments, the precursor is selected from the group consisting of Na₂SiO₃, Na₂B₄O₇, Mg(OAc)₂, Ni(NO₃)₂, and combinations thereof.

In preferred embodiments of the invention, the deposition of the coating liquid is performed by using technology based on inkjet printing. The inkjet technique has many advantages over other methods known in the art. For example, it is able to cover large areas within short time with a layer having a very well-defined thickness and structure. The inkjet technique can be used for single material deposition in a compact layer as well as in a patterned layer with partial surface coverage. In contrast to blade, dip or spray coating, the inkjet technique enables the deposition of a two-dimensional pattern with partial surface coverage. Furthermore, it enables the deposition two or more materials onto a single substrate to create complex two-dimensional multi-functional patterns.

The versatility of inkjet printing techniques provides a number of options to achieve multi-functional coatings. With the inkjet process different coating types and morphologies can be achieved. Non-limiting examples include:
homogeneous coating layers with full surface coverage and uniform layer thickness;
coating layers with partial surface coverage, keeping individual drops/pixels or groups of drops/pixels such as line separated;
coating layers with partial surface coverage, where the shape of the dried ink drops creates an additional functionality, e.g. the dried droplet creates a lens shaped dot;
coating layers consisting of two or more type of inks;
coatings consisting of two or more material layers; and,
multi-layer coatings with complex geometry to interconnected different layers.

The heating step provides the mechanical stability to the coating. As they are heated, the particles start to sinter together, providing excellent mechanical stability of the coating and strong adhesion to the glass substrate.

### C. Preparation of Coating Material

The chemical composition of the coating is defined by the composition of the coating liquid. The coating liquid comprises a solvent (preferably water), a precursor dissolved in the solvent, and suspension of particles in the solvent. In some preferred embodiments, the final chemical composition of the coating is obtained via a chemical reaction such as oxidation that occurs during the drying or heating step. The composition of the coating liquid is chosen so that the final coating will have a homogeneous thickness and chemical composition. The description below emphasizes the considerations for preparation of a coating material for deposition by inkjet printing. A person of ordinary skill in the art will understand the adjustments in the composition that are necessary to provide an optimal coating when other deposition methods are used. Non-limiting examples of deposition methods that can be used to produce coatings of the invention disclosed herein include Mayer or forming rod coating, spraying, and dip coating.

The coating liquid (also referred to as the “ink,” particularly when it is deposited by inkjet printing methods) comprises the starting materials from which the coating will be formed and a carrier liquid or solvent. In preferred embodiments of the invention, the coating liquid is selected from one of three types:
1. A coating liquid in which an ink where a precursor material is dissolved in the carrier liquid (solution ink);
2. A coating liquid in which particles of starting material (preferably selected from the group consisting of microparticles, sub-micron sized particles, particles, and combinations thereof) are dispersed in the carrier liquid, e.g. as a suspension or dispersion (dispersion ink); and,
3. A coating liquid that comprises dispersed particles and dissolved precursor (dispersion-solution ink).

A solution ink comprises a carrier liquid (a solvent) into which materials that will be deposited onto the substrate are dissolved. These materials will form the coating after the solvent is removed, in some embodiments, via chemical reaction that occurs prior to, during, or after their deposition. Non-limiting examples of suitable materials include salts, neutral molecules, chemical complexes, and ionic liquids. In some preferred embodiments of the invention, the dissolved material comprises metal atoms or ions.

A dispersion ink contains particles (preferably sub-micrometer or nanometer) of the material to be deposited, suspended in the carrier liquid or dispersed in the carrier liquid by a dispersant. Non-limiting examples of particles that can be used in the invention disclosed herein include metal particles and particles of insoluble metal compounds, such as metal oxides, metal sulfides, metal phosphides, and metal nitrides.

A solution-dispersion ink is a combination of a solution ink and dispersion ink that contains particles in suspension or dispersed by a dispersant and a dissolved precursor in the carrier liquid. The dispersed particles and the dissolved precursor can have a different chemical composition, leading to a composite material following deposition onto the substrate.

In typical non-limiting embodiments of dispersion and solution-dispersion inks, the dispersed or suspended particles comprise on the order of 1 wt % of the ink.

For the deposition of two or more different inks a chemical reaction of two inks can be used for material synthesis when the droplets are deposited onto the same location (the same pixel).

The carrier liquid is chosen so as to meet the chemical and physical requirements of the ink. As a non-limiting example of the chemical requirements of the ink, in solution or solution-dispersion inks, the precursor has to be at least sparingly soluble in the carrier liquid. As non-limiting examples of the physical requirements of the ink, the viscosity and surface tension of the carrier liquid are chosen so as to meet the requirements of the deposition system (e.g. an inkjet print head) in order to produce well shaped droplets without spraying. In some embodiments of the invention, these requirements are met by mixing different solvents with different surface tensions, viscosities, and boiling points. If the ink is jetted onto a hot substrate, then the boiling point of at least one solvent component should be sufficiently higher than the substrate temperature to ensure that the carrier liquid is above its Leidenfrost point, i.e. in order to prevent rapid evaporation from the surface of the droplet followed by droplet hovering on a layer of vapor.

In some embodiments of the invention, the ink comprises a suspension or dispersion of uniform (monodisperse) particles. In some preferred embodiments, the particles are characterized by a diameter of 2-200 nm. In some other preferred embodiments of the invention, the particles are characterized by a diameter of 80-150 nm. In yet other embodiments of the invention, the particles are characterized by a diameter of x nm, where x is selected from the group consisting of 5, 8, 10, 12, 15, 20, 25, 30, 35, 40, 50, 60, 70, 80, 85, 90, 100, 120, 150, and 200.

In some embodiments of the invention, the ink comprises a suspension or dispersion of a mixture of particles characterized by two different sizes. In some preferred embodiments of the invention, the particles are characterized by diameters of between 2 and 200 nm. In some other preferred embodiments of the invention, the particles are characterized by diameters of 80-150 nm. In yet other preferred embodiments of the invention, some of the particles in the mixture are characterized by diameters of 2-30 nm, while other particles in the mixture are characterized by diameters of 50-120 nm. In preferred embodiments of the invention, the particles are characterized by diameters that differ by at least 20 nm. In some embodiments of the invention, the particles have diameters of x nm and y nm, respectively, where where x and y are selected from the group consisting of 5, 8, 10, 12, 15, 20, 25, 30, 35, 40, 50, 60, 70, 80, 85, 90, 100, 120, 150, and 200 and the difference between x and y is at least 20.

In some embodiments of the invention, the ink comprises a suspension or dispersion of a mixture of particles characterized by three or more different sizes. In some preferred embodiments of the invention, the particles are characterized by diameters of between 2 and 200 nm. In some other preferred embodiments of the invention, the particles are characterized by diameters of 80-150 nm. In yet other preferred embodiments of the invention, some of the particles in the mixture are characterized by diameters of 2-30 nm, while other particles in the mixture are characterized by diameters of 50-120 nm. In preferred embodiments of the invention, the particles are characterized by diameters that differ by at least 20 nm. In other embodiments of the invention, the particles are characterized by diameters selected from the group consisting of (in nm) 5, 8, 10, 12, 15, 20, 25, 30, 35, 40, 50, 60, 70, 80, 85, 90, 100, 120, 150, and 200 and the difference between any two different particle diameters is at least 20 nm.

In some embodiments of the current invention the ink comprises a suspension or dispersion of particles characterized by a non-uniform (polydisperse) size distributions with particle diameters ranging from 4-200 nm.

In preferred embodiments of the invention in which the coating liquid comprises a dispersion or solution-dispersion ink, the particles dispersed or suspended in the carrier liquid comprise a refractory material. Non-limiting examples of suitable materials for suspension or dispersion in the carrier liquid include SiO₂, TiO₂, ZrO₂, SnO₂, doped SnO₂, Fe₂O₃, and combinations thereof. Non-limiting examples of suitable materials for embodiments that include more than one material include at least two materials selected from the group consisting of SiO₂, TiO₂, ZrO₂, SnO₂, doped SnO₂, Fe₂O₃, Ag, Au, Mg, Ti, Al and Mn. In some preferred embodiments of the invention, the suspension or dispersion is prepared from SiO₂ and at least one other substance that provides a desired property. Non-limiting examples include nanoparticulate TiO₂, which imparts photocatalytic activity to the coating, and particles of a metal such as Ag, which impart low emissivity to the coating. In these embodiments, the solid content is preferably at least 50% SiO₂ by volume, and more preferably more than 95% SiO₂ by volume.

Non-limiting examples of substances that can be used as the carrier liquid include water, methanol, ethanol, isopropanol, 1-propanol, 1-butanol, 2-butanol, isobutanol, tert-butanol, p-tert-octylphenoxypolyethoxyethyl alcohol, acetone, cyclohexane, toluene, butyl acetate, ethyl acetate, benzene, xylene, chloroform, diethyl ether, dichloromethane, dimethylformamide, acetonitrile, propylene carbonate, acetic acid, ammonia, formic acid, polyethylene glycol (PEG), polypropylene glycol, polyvinyl acetate, glycerine, and mixtures thereof. In preferred embodiments of the invention, the carrier liquid is water.

In some non-limiting embodiments, the coating liquid is a water-based solution-dispersion ink comprising dispersed SiO₂ particles (preferably on the order of 1 wt %), a wetting agent, and PEG 400 (preferably −2 mM) to increase the homogeneity of the deposited coating. The ink comprises at least one precursor in solution, preferably selected from the group consisting of 1-20 mM Na₂SiO₃, 0.5-5 mM Na₂B₄O₇, and 0.5-5 mM Mg(OAc)₂. In preferred embodiments of the ink, it comprises 0.1-10 mM PEG and 1-10 mM TPE. In some embodiments, the SiO₂ particles are of uniform size. In other embodiments, the SiO₂ particles have a non-uniform size distribution, preferably with diameters of up to 120 nm. In yet other embodiments, the SiO₂ particles may have a bimodal size distribution, a non-limiting example of which is small particles having diameters ≤30 nm and large particles having diameters >50 nm.

In some non-limiting embodiments, the coating liquid is a water-based solution-dispersion ink for use in the preparation of a coating that has AR, anti-soiling, and photocatalytic properties that comprises SiO₂ and TiO₂ particles (preferably on the order of 1 wt %), in which the TiO₂ particles comprise less than 5% by volume of the solids. The ink may comprise a wetting agent, PEG, TPE, and precursors in solution as described above.

In some non-limiting embodiments, the coating liquid is a dispersion ink for deposition of super-hydrophobic pixels comprising a dispersion of sub-micron diameter ZrO₂ spheres (preferably on the order of 1 wt %) dispersed in a carrier liquid comprising a mixture of isopropanol and glycerol.

In some non-limiting embodiments, the coating liquid is a solution-dispersion ink for deposition of photocatalytic, AR, and super-hydrophobic pixels, comprising a Ti-containing precursor in solution together with dispersed SiO₂ spheres. The SiO₂ spheres can be solid or hollow and typically have a diameter of 4-500 nm. After deposition of the coating liquid on the substrate, the heating step, described in detail below, activates a pyrolysis reaction that converts the Ti precursor to TiO₂ while keeping the SiO₂ spheres together, thereby creating a highly structured hydrophilic surface with photocatalytic properties due to the TiO₂ coating of the SiO₂ spheres. The rough surface structure of the resulting coating, which is characterized by a gradient in the ratio of coating material to void from the upper surface of the coating to its interface with the substrate, thereby resulting in a gradual change of the refractive index as a function of depth and providing the coating with AR properties.

In some non-limiting embodiments, the coating liquid is a dispersion ink for use in the preparation of a low-emissivity coating with anti-soiling properties, comprising SiO₂ particles and Ag particles in which the Ag particles comprise less than 5% by volume of the solids, and the total dispersion is preferably on the order of 1 wt % of the ink. Deposition and drying of the ink, followed by heating of the substrate, leads to embedding of the Ag particles in the SiO₂ matrix, and thereby to a coating with high transparency to visible light and high reflectance in the IR.

In some non-limiting embodiments, the coating liquid is a water based solution-dispersion ink comprising a mixture of particles of SiO₂, TiO₂, Ag, and two additional substances A and B, wherein A is selected from the group consisting of SnO₂, F:SnO₂, and Sb:SnO₂, and B is selected from the group consisting of Al₂O₃ and ZrO₂. The ink additionally comprises at least one precursor in solution. In preferred embodiments of the invention, the precursor solution comprises at least one substance selected from the group consisting of 1-20 mM Na₂SiO₃, 0.5-5 mM Na₂B₄O₇, 0.5-5 mM Mg(OAc)₂, and 0-5 mM Ni(NO₃)₂. The ink additionally comprises 0.1-10 mM PEG and 1-10 mM TPE. In typical embodiments, the SiO₂ and TiO₂ particles have a Gaussian size distribution with an average diameter of about 15 nm and σ of about 10 nm. The particles of substance A typically have diameters of 15-100 nm, and the particles of substance B typically have diameters of 5-100 nm.

In some non-limiting embodiments, a coating liquid is prepared for preparation of a coating comprising super-hydrophobic pixels. One non-limiting example of such a coating liquid is a dispersion ink comprising submicron spheres of ZrO₂ dispersed in a carrier liquid consisting of a mixture of isopropanol and glycerol. During the heating step following deposition, partial sintering of the ZrO₂ particles takes place, producing a sub-micron structured surface with super-hydrophobic properties.

In some non-limiting embodiments, two separate coating liquids are prepared in order to produce a two-layer coating. In some preferred embodiments, the first coating liquid comprises a dispersion of a mixture of particles of SiO₂ and particles of at least one of SnO₂, F:SnO₂, and Sb:SnO₂. The coating liquid preferably contains precursors, PEG, and TPE in solution as described above. In some preferred embodiments, the second coating liquid comprises a dispersion of a mixture of particles of SiO₂, TiO₂, and at least one of ZrO₂ and Al₂O₃. In preferred embodiments, the second coating liquid also comprises a precursor in solution, PEG, and TPE, as described above. The first coating liquid is deposited on the substrate and dried, and then the second coating liquid is deposited atop the first coating liquid, thereby producing a two-layer coating.

As explained in detail below, a multiple-layer coating in which each layer comprises a different composition can be produced for any arbitrary number n of desired layers by producing n independent coating liquids and then depositing them sequentially on the substrate. As a non-limiting embodiment that comprises four coating liquids for use in the production of a four-layer coating, the first coating liquid is used to produce a transparent conductive oxide (TCO) layer characterized by a sheet resistance of less than 100 Ω/square. This first coating liquid comprises a solution-dispersion ink containing particles of SiO₂ or doped SnO₂ such as F:SnO₂ or Sb:SnO₂; and in preferred embodiments, a solution of precursor as described above, PEG and TPE as described above. It is also possible to use a commercially available TCO layer. The second coating liquid is for the production of an electron-accepting second layer, and comprises a mixture of SiO₂ and SnO₂ particles; in preferred embodiments, the second coating liquid additionally comprises precursors such as Na₂SiO₃, Na₂B₄O₇, and/or Mg(OAc)₂ in solution; in preferred embodiments, the second coating liquid comprises PEG and/or TPE, as described above. The third coating liquid is for preparation of a hole-accepting layer, and comprises a mixture of SiO₂ and TiO₂ particles in suspension or dispersion; in preferred embodiments, the third coating liquid additionally comprises precursors, and PEG and/or TPE as well. The fourth coating liquid is for preparation of a hole conducting layer comprising NiO particles, and comprises a solution of a soluble Ni(II) salt, preferably Ni(NO₃)₂, and preferably in a concentration of 1-50 mM. In preferred embodiments, the fourth coating liquid comprises PEG and/or TPE as well.

In some embodiments of the invention, the carrier liquid comprises additives. In various non-limiting embodiments of the invention, these additives serve to optimize the rheology of the ink to the specific deposition system; to improve the ability of the ink to wet the particular substrate onto which it is to be deposited; to improve the wetting properties of the substrate surface; or to optimize jetting and drying properties. Non-limiting examples of suitable additives include organic additives such as waxes, plasticizers, defoaming agents, thixotropy promoters, anti-skinning agents, adhesion promoters, and driers.

### D. Deposition of the Coating Liquid on a Substrate

The deposition process consists of ejecting droplets of ink from a reservoir and passing the droplets onto the surface of a flat substrate in a predetermined pattern. In preferred embodiments of the invention, the deposition process is performed by using inkjet printing technology. The printer used to deposit the ink has at least one printing unit that contains at least one print head. If more than one type of ink is to be printed, multiple printing units can be used.

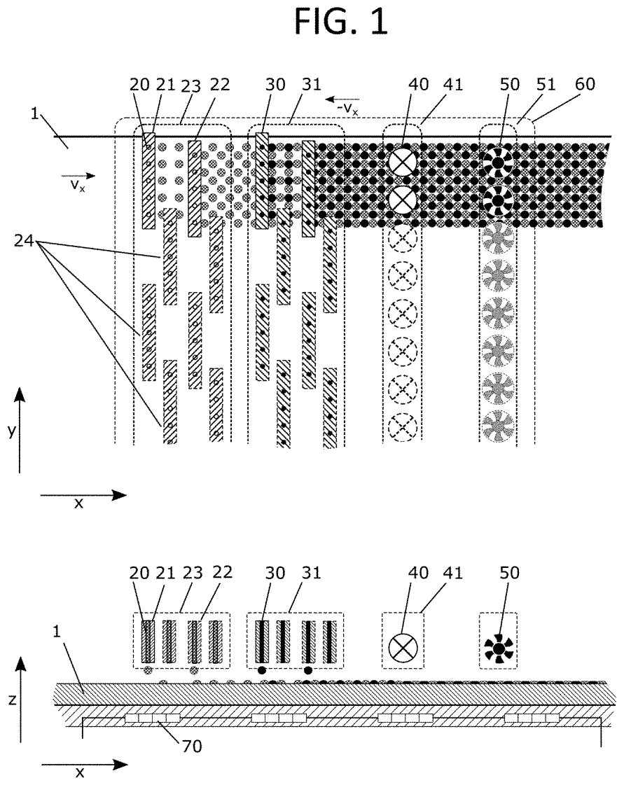

Reference is now made to FIG. 1, which presents a schematic drawing of an inkjet printer unit for the deposition of self-cleaning coatings onto flat surfaces as described herein, showing a top view (top) and a side view (bottom). At least one print head (21, 22) deposits droplets of at least one type of ink onto substrate 1; the number of print heads is determined by the user according to the immediate needs of the system. The system shown in FIG. 1 should thus be considered illustrative only and in no way limiting. The substrate is a flat surface that moves with velocity vₓ relative to the printing nozzles 20 of the at least one print head. Non-limiting examples of substrates on which the coatings disclosed herein can be deposited by the method disclosed herein include glass, metal, ceramic materials, and stone.

The distance between neighboring droplets defines the pixel size. For a single print head, the pixel size in the y direction is determined by the spacing of the printing nozzles of the print head. The distance between pixels can be reduced by adding additional print heads in series with a small offset in the y direction, as shown in the figure for print heads 21 and 22. In order to simplify coverage of larger areas, in some embodiments, additional print heads 24 are mounted in parallel. Print heads that deposit one type of ink form a first print unit 23.

In preferred embodiments of the invention in which more than one type of ink is deposited, additional print units 31 comprising independent sets of print heads 30 are used. Illustrated in FIG. 1 is a non-limiting example of one such embodiment, in which two different inks are used to produce a coating with a chessboard-like pattern. As discussed in detail below, the ink can be deposited onto a hot surface or it can be dried and further heated by independent drying (41) and heating (51) units. These units and their properties are discussed in detail below.

The inkjet printer unit optionally comprises means 60 for heating, drying, chemical activation, or a combination thereof. These heating, drying, or chemical activation means can be integrated into the glass production process of flat glass. In these embodiments, the ink is deposited onto the glass while the glass is still hot.

The pixel size is defined by the spacing between locations where droplets are deposited, measured from the center of one droplet location to the center of the neighboring locations.

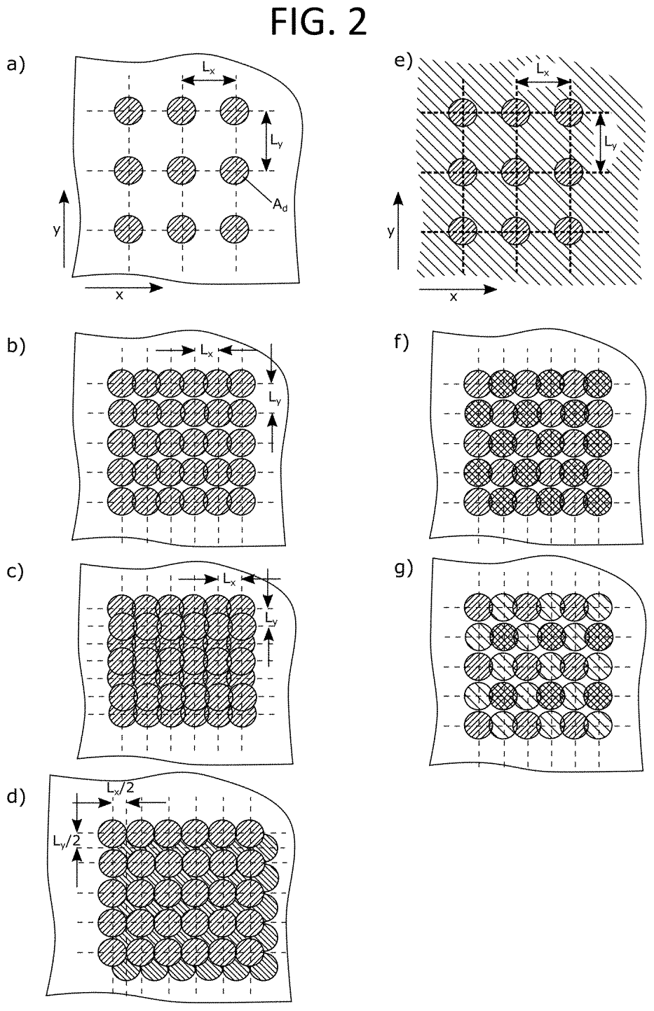

Reference is now made to FIG. 2, which illustrates schematically several non-limiting embodiments of deposition spacings and patterns that can be achieved by using the method disclosed herein. FIG. 2A illustrates schematically a substrate partially covered with droplets deposited by an inkjet head. The droplet spacing L_{y} is defined by the nozzle spacing of the print head and the number of print heads that are connected in series within the print head unit. The droplet spacing Lₓ is defined by the velocity of the substrate relative to the print head vₓ and the jetting frequency η: Lₓ=vₓ/η. The droplet footprint A_{d} is defined by the type of substrate surface, its temperature, the ink composition and the evaporation rate. The pixel size is defined by Lₓ×L_{y}. FIG. 2B illustrates schematically a substrate covered with an inkjet deposited layer, where the droplet footprint and the pixel size are approximately the same. FIG. 2C illustrates schematically an inkjet deposited layer with a smaller pixel size than the droplet footprint, leading to a partial overlap of the droplets and a full surface coverage. FIG. 2D illustrates schematically an inkjet deposited coating where full surface coverage is achieved by two layers printed on top of each other, where the second layer is shifted by Lₓ/2 and L_{y}/2 with respect to the first layer. FIG. 2E illustrates schematically a multi-functional layer deposited by inkjet printing, where a layer with partial surface coverage is printed onto a homogeneous pre-deposited coating. A non-limiting example of a layer that can be prepared in this fashion is a layer comprising super-hydrophilic nano-structured ZrO₂ pixels deposited onto a commercially available glass covered with a MgF₂ anti-reflection coating. FIG. 2F illustrates schematically a multi-functional layer deposited by inkjet printing of two different inks, leading to a surface coverage with two kind of pixels with different functionalities. FIG. 2G illustrates schematically a multi-functional coating based on three different type of pixels. Multi-functionality is achieved when the dimension of an entity which is interacting with the surface is larger than the pixel size, for example the contact area of a droplet with the coating. If one type of pixel is super-hydrophilic while the other is anti-reflecting or photo-catalytic, then the droplet will experience the effect of both type of materials.

A pixel can be rectangular or square in shape. The pixel size is defined by the repetition rate of jetted droplets (jetting frequency), the velocity of the substrate relative to the print head, and the spacing between the nozzles of the print head. To reduce the pixel size below the nozzle spacing, several print heads can be aligned in series as was shown in FIG. 1, or the print heads can be tilted relative to the substrate.

If the pixel area is larger than the footprint of a droplet on the substrate, then only partial surface coverage is achieved with a single printed layer. In this way an additional property can be incorporated onto a surface. Full surface coverage is achieved if the pixel size corresponds to the droplet footprint or is smaller than that, or if multiple layers are printed on top of each other with a shift relative to each other.

In some embodiments of the invention disclosed herein, the high lateral resolution of the inkjet printing process is used to merge the functionality of different homogeneous coatings. A sophisticated two-dimensional pattern can be produced if one type of ink is used with partial surface coverage or if more than one type of ink is used to create a pattern made up of multiple pixels, as shown in FIG. 2.

In some embodiments of the invention, particularly for multi-functional coatings, a structure having multiple layers is desired or in some cases required. In some embodiments of the invention disclosed herein, multiple layers are provided by depositing a layer that may partially or completely cover the substrate, drying that layer, depositing an additional layer that likewise may completely or partially cover the substrate, drying the additional layer, and repeating the steps of depositing and drying as necessary to produce the desired number of layers.

In some embodiments of the invention disclosed herein, multi-functionality of a coating based on one ink is achieved by printing a layer with incomplete surface coverage onto a fully pre-coated surface characterized by a different functionality. As a non-limiting example, a layer with partial surface coverage of photocatalytic pixels can be deposited onto a glass plate with a pre-deposited homogeneous AR coating. While the photo-catalytic pixels in principle might reduce the AR effect on the area where they cover the substrate, the average effect of the entire layer will be anti-reflecting with a self-cleaning photocatalytic coating that decomposes dirt particles that have accumulated on the surface.

In some embodiments, coatings based on two or more different inks are used to produce a two-dimensional pattern of different pixels where each pixel type provides a different effect. As a non-limiting example, the coating could combine super-hydrophobic pixels with pixels that are characterized by a pronounced AR effect. As long as the pixel size of the super-hydrophobic material is significantly smaller than the contact area of a water droplet impinging on the surface, a super-hydrophobic effect can be achieved even with incomplete surface coverage of the super-hydrophobic pixels. In this manner, multiple functionalities can be incorporated into one layer by geometrically merging the properties of two materials at the pixel scale.

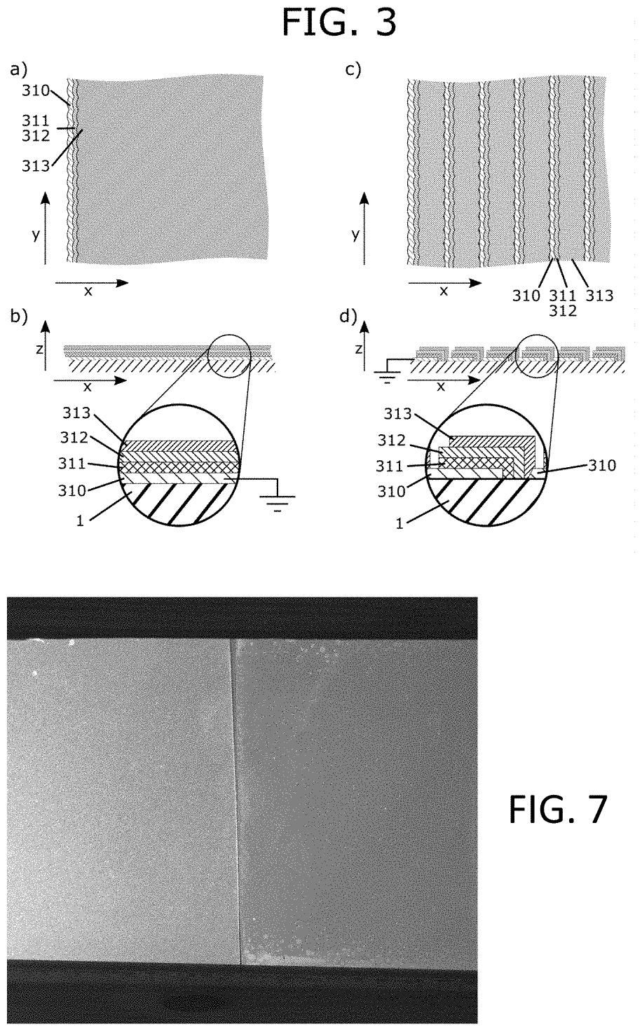

Reference is now made to FIG. 3, which presents schematic depictions of several non-limiting embodiments of layered coatings prepared according to the method disclosed herein. As shown in FIG. 3, the lateral resolution of the inkjet deposition technique provides the ability to connect different layers of the incipient coating.

FIGS. 3A and 3B present schematic drawings (top view and cross-section, respectively) of a layered coating comprising four layers deposited on top of each other by inkjet printing onto a flat substrate material 1. Electrically charged surfaces can be realized by such structures. As a non-limiting example, if layer 310 is an electron accepting transparent conducting layer (e.g. a layer comprising F:SnO₂), layers 311 and 312 are wide band gap semiconductors of which at least one layer absorbs a small fraction of the solar spectrum, and layer 313 is a transparent hole accepting layer, then upon solar illumination, electrons and holes are generated in layer 311 or in layer 312 or in both. The electrons and holes are separated at the interface between layer 311 and layer 312 and electrons are transferred towards the layer 310 while holes are transferred towards layer 313, where they charge the surface and repel positively charged dust particles. If the stacking order of layers 311 and 312 is reversed, electrons can be accumulated in layer 313 and holes in layer 310, providing that the interfaces between layers 311 and 310 and the interface between layers 312 and 311 permit such a transfer.

As with single-layer coatings, the method disclosed herein enables preparation of multiple-layer coatings in which rather than completely coating the substrate, each of the layers is deposited according to a predetermined two-dimensional pattern. As a non-limiting example, each of the layers can be deposited as a line. Reference is now made to FIGS. 3C and 3D, which illustrate schematically preparation of a multiple-layer coating in which the coating material is deposited as lines. In the example shown in the illustration, four layers are prepared, but a person of ordinary skill in the art will understand that any arbitrary number of layers may be produced by this method.

FIG. 3C presents a schematic top view of a layered coating that illustrates how the inkjet technique allows separation of the layers and their interconnection, where the droplets have been printed in y-direction with a sufficient overlap to form stripe shaped layers. FIG. 3D presents a schematic view of an embodiment comprising a small offset between layer 310 and layers 311 and 312 that leaves a small area of layer 310 uncovered, so that it can be brought in contact with layer 313. In this way higher surface voltages can be achieved when the first layer strip is grounded.

In the examples shown in FIGS. 3C and 3D, four coating liquids are prepared separately. Layer 311 is deposited from the first coating liquid on the substrate as a set of lines separated one from the other; the gap between the lines can be quite small (<10 μm), given the high resolution of the inkjet printing process. After layer 311 is deposited, layers 312, 313, and 314 are deposited from the second, third, and fourth coating liquids, respectively, as lines. In the embodiment illustrated in the figure, each line is slightly shifted with respect to the layer below it so as not to cover the layer below it completely, while still not touching the neighboring lines. The uppermost layer 314 can be deposited as a line and shifted with respect to layers 311, 312, and 313 to connect with the neighboring lines of layer 311, thereby producing an electrical series connection of the different lines.

As the examples presented in FIG. 3 demonstrate, layered structures comprising more than one type of particle can be produced. This ability enables deposition of a stack of layers with different functionalities; as a non-limiting example, an adhesion layer can be deposited between the glass substrate and a self-cleaning layer. In some cases, this ability is critical; for example, anti-soiling coatings with an electrostatic surface charge require a layered structure, as explained below.

As a further non-limiting example, the method disclosed herein can produce a layered system with a charge separating junction in between conducting transparent oxides (TCO), where the front TCO is connected with back TCO of the neighboring pixel. This can be of particular interest for surfaced charged pixels, which can be electrically interconnected in series to achieve in defined locations higher surface potentials, for examples at the edge close to window frames, where dust and dirt accumulation is pronounced.

### E. Drying the Coating

After deposition, the incipient coating layer is dried. Any means for drying the coating known in the art can be used. As non-limiting examples, the drying can be performed passively, e.g. in ambient air or under an inert atmosphere, or actively by means such convection in which air or other gas is blown over the layer (e.g. by a fan) or by heating (e.g. conductively by radiation by passing heated air or other gas over the incipient coating).

In some embodiments, a chemical reaction takes place before, during, or after the drying process. The chemical reaction can occur spontaneously or it can be activated externally. Non-limiting examples of means for externally activating a chemical reaction include activating the reaction by heating, whether conductively (e.g. from a heater below the substrate), convectively (e.g. from a blower system), or radiatively, (e.g. from a UV, VIS, or IR lamp or an x-ray source); by passing a vapor or gas comprising a reactive substance over the coating as it dries; or by applying a second ink deposited by a different print head on top of the droplets deposited by the first printing unit, the second ink comprising at least one component that can react with or induce reaction in at least one component of the first ink.

In typical embodiments in which the coating comprises a plurality of n layers, each layer from the first through the (n−1)th is dried prior to the deposition of the succeeding layer.

In addition, combinations of activation processes are within the scope of the invention; a non-limiting example is heat assisted light-activated reactions.

### F. Heating the Coating

In preferred embodiments of the invention, the final step in the process of forming the coating is heating. In some embodiments of the invention, heating is used to remove organic content of the dried coating layer, to sinter particles deposited on the substrate together in order to form a porous network, to give the coating a high mechanical strength and good adhesion to the substrate, to activate chemical reactions that occur after the deposition of the coating liquid onto the substrate (e.g. oxidation of the precursor material), or a combination of two or more of these processes.

In preferred embodiments of the invention, the heating profile is similar to tempering profiles used in glass processing. In these embodiments, the maximum heating temperature is typically between 630° C. and 680° C., depending on the type and composition of the substrate.

The heating can be performed by any method known in the art. FIG. 1 illustrates a non-limiting embodiment in which the heating is done radiatively. In the embodiment illustrated in the figure, heating unit 41 comprises a singe radiation source 40. In other embodiments (not shown in the figure), the heating unit comprises an array of radiation sources, which can be lamps that radiate in the visible spectrum, IR, UV, or over a span that bridges the visible with one or both of the IR and UV regions.

In some embodiments of the invention, radiative or conductive heating of the substrate is performed by using one or more heating elements 7 disposed below the substrate.

In some embodiments of the invention, instead of or in addition to a radiative heat source, heat is applied to the printed layer using a blower unit that can consist of a single blower 50 or an array of blowers 51. In some embodiments of the invention, the blower unit is used to blow vapor or gas over the printed droplets that activate a chemical reaction, either among materials found in the coating liquid or between the vapor or gas and one or more components of the heating liquid.

In embodiments of the invention in which the coating comprises a plurality of layers, the heating step is preferably performed after all of the layers have been deposited and dried.

### G. Pixel Properties—Self-Cleaning Coatings

A self-cleaning coating can be obtained in a variety of ways. As non-limiting examples, the pixels can have a hydrophilic, a hydrophobic, super-hydrophobic, or a photocatalytic surface; the surface can have a very low sticking coefficient for dust and dirt; or the surface can have an electrostatic surface charge that will repel charged dust particles or charge and repel initially uncharged particles.

In some non-limiting embodiments of the invention, a self-cleaning coating is obtained from layers containing pixels with a highly hydrophilic surface. As a non-limiting example, the coating liquid can comprise a titanium-containing precursor, deposition of which is followed by pyrolysis during the heating step that converts the precursor into TiO₂.

In some non-limiting embodiments of the invention, a self-cleaning coating is obtained by incorporation of a layer containing pixels having an ultra-hydrophobic surface. This effect can be achieved with micro-, submicro-, or nano-structured surfaces. Non-limiting examples of coating geometries and materials that will provide this effect include vertically aligned or randomly oriented nano-rods or tubes that made from at least one substance selected from the group consisting of ZnO, SnO₂, TiO₂, SiO₂, and ZrO₂.

In some non-limiting embodiments of the invention, a self-cleaning coating is obtained from photocatalytic properties of the coating. The photocatalytic material absorbs a portion of the solar radiation impinging upon it, thereby generating electron-hole pairs, followed by diffusion of the hole to the surface of the coating and oxidation of particles that are contaminating the surface, thereby chemically decomposing and removing the contaminating particles from the surface. Non-limiting examples of photo-catalytic materials useful in the current invention include Fe₂O₃ and TiO₂, which can also be added in small quantities to porous films made from nanoparticulate ZnO, SnO₂, SiO₂, or ZrO₂.

In some non-limiting embodiments of the current invention, a self-cleaning coating is obtained from a layered structure comprising at least two layers of which at least one layer absorbs a portion of the solar radiation impinging upon it. The layer stack has photovoltaic activity when the interface of at least two layers forms a charge separating junction. The layer close to the substrate should be conducting or at least semi-conducting and has to be grounded so that upon exposure to sunlight the outer surface will be biased. Self cleaning is achieved by electrostatic charging of dust and dirt particles that touch the coating, followed by electrostatic repulsion. This type of coating is of particular importance for desert areas where the cleaning effect has to be achieved in the absence of water.

The effect of electrostatic repulsion from surface charged pixels is stronger when more charge is transferred to the dust particle; the charge transfer to the dust particle will depend on the potential. The soiling effect on flat glass panels is usually not homogeneous and stronger soiling is observed towards the bottom of a panel or at the edges where the frame disturbs the flat topology of the surface. In such areas of the glass that have more pronounced dust accumulation, higher potentials are desired for anti-soiling or self-cleaning. Connecting the charged pixels or groups of pixels (patches) in series will allow to provide an inhomogeneous potential distribution across the surface as shown, for example, in FIG. 3C.

In some non-limiting embodiments of the invention, a self-cleaning coating is constructed of layers that combine some of the effects described above in to achieve the self-cleaning functionality.

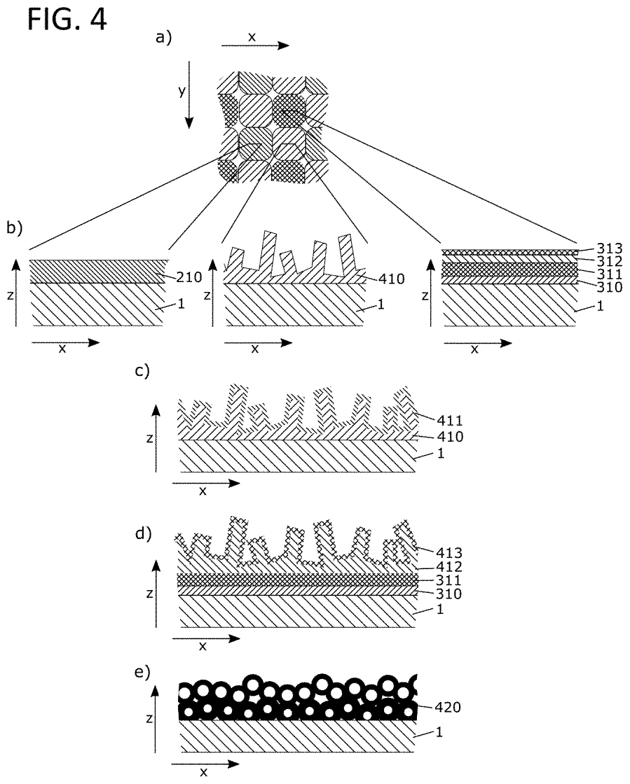

Reference is now made to FIG. 4, which illustrates the principles behind these embodiments. FIGS. 4A and 4B present schematic top and cross-sectional views, respectively, of a coating consisting of three different types of pixels, shown in different gray scales, deposited onto substrate 1. The left side of FIG. 4B shows a smooth pixel surface 210 that can be hydrophilic or photo-catalytic. In the middle, a pixel 410 is shown that is characterized by a micro-, sub-micro-, or nano-structured surface and hydrophobic or super-hydrophobic properties. On the right-hand side of FIG. 4B, a pixel is shown that consists of a multi-layered structure for partial light absorption, for example in layer 311 or 312. Charge carrier separation occurs at the junction between the layers 311 and 312, while subsequent charge transfer to layers 310 and 313 builds up a surface charge for electrostatic repulsion of dust particles.

FIG. 4C presents a schematic cross-section of a pixel with combined properties. The example shows a micro-, sub-micro-, or nano-structured surface 410 that is coated with another layer which can be photo-catalytic or which improves properties of the structured surface, for example improved chemical stability in ambient conditions or enhanced mechanical stability.

FIG. 4D presents a schematic cross-section of another example of a pixel with combined properties that shows multi-layered structure to generate a surface charge, where one of the layers (in this case layer 412) has a micro-, sub-micro-, or nano-structured morphology that gives it additional hydrophobic or super-hydrophobic properties. In one non-limiting embodiment of the invention, the layer has an electrically charged super-hydrophobic surface structure. A rough surface morphology is used to enhance the electric field at the tips of the micro-, sub-micro and nano-structures on the surface for enhanced charging and repulsion of particles approaching the coating.

FIG. 4E presents an example of a coating with AR and photocatalytic or hydrophilic surface properties. Hollow spheres with a systematically decreasing wall thickness towards the outer surface provide an AR effect, while the sphere material itself can have photocatalytic or hydrophilic surface properties. Heat treatment provides the mechanical stability in between the spheres.

For photovoltaic windows, the coating should have AR properties in addition to being self-cleaning effect. The required gradual change of the refractive index is achieved by the micro, sub-micro or nano-structure of the pixel. A discussed above, for a layered flat system, the refractive index of the self-cleaning layer has to be between the refractive index of air and that of the glass substrate in order to achieve reduced reflectivity, restricting the choice of materials. If the dimensions of the surface structure are smaller than the wavelength of the incident light, then the refractive index can be approximated by an effective refractive index that depends on the ratio of material to voids, which in a structured surface gradually increases from 0% to 100%. Consequently, micro-, sub-micro- and nano-structured surfaces can have AR properties. Furthermore, hollow particles, for example spherical particles, with a diameter in the micro-, sub-micro, or nano-regime can be used to produce a medium with an effective refractive index in between that of air and that of the substrate material.

In some non-limiting embodiments of the invention, hollow sub-micro or nanospheres or sub-micro or nanotubes made from a photocatalytic material such as TiO₂ and having a systematically varying wall thickness are used to produce a gradually changing refractive index. As shown in FIG. 4E, such a coating has AR properties as well as photocatalytic cleaning properties. A similar effect can be achieved when particles are partially sintered together during the heating step such that they form a mesoporous network.

In some non-limiting embodiments of the invention, the coating combines self-cleaning with a low emissivity. This combination of properties is produced by adding metal particles selected from Ag, Au, Al, or Pd to a layer containing pixels made from ZnO, SnO₂, TiO₂, SiO₂ or ZrO₂ particles. The materials can have uniform (monodisperse) or nonuniform (polydisperse) size distributions. Coatings made from this material are highly robust with good abrasion resistance and long lifetimes.

### EXAMPLES

The following examples are presented to enable a person of ordinary skill in the art to make and use the invention disclosed herein, and are not intended to be limiting in any way.

### Example 1

### Ink with SiO₂ Particles Having a Uniform Size and Anti-Soiling Mesoporous AR Coating Produced Therefrom

A water-based ink was prepared that contained dispersed SiO₂ nanoparticles (1 wt %), a wetting agent, and 2 mM PEG 400 to increase the homogeneity of the deposited coating. Three different samples were prepared, in which the SiO₂ nanoparticles had diameters of 5, 15, and 20 nm, respectively. It was found that the best anti-abrasion behavior of the final coating was obtained when the ink additionally included 10 mM Na₂SiO₃, 1 mM Na₂B₄O₇, and 1 mM Mg(OAc)₂ in solution as precursors. The ink had a pH of 10-11.5.

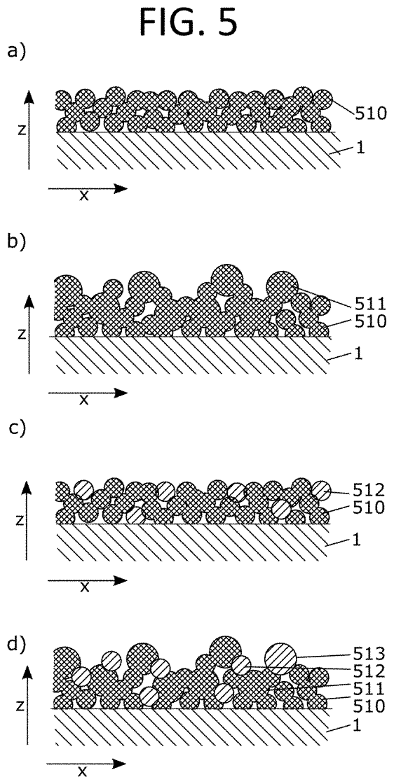

A coating was prepared on a glass substrate from the ink according to the method disclosed above. Complete surface coverage is achieved by depositing the ink with a drop spacing that is smaller than the diameter of a single droplet deposited onto the glass substrate. Drying was carried out in ambient air, followed by heating in air for 30 min at 610° C. Reference is now made to FIG. 5A, which presents a schematic cross section of a homogeneous mesoporous film made from particles 510 of a single material such as SiO₂ having a uniform particle size deposited onto a substrate (1).

### Example 2

### Ink with SiO₂ Particles Having a Nonuniform Size Distribution and Anti-Soiling Mesoporous AR Coating Produced Therefrom

An ink comprising SiO₂ particles was prepared similarly to that described in the previous example, but comprising particles having a nonuniform (polydisperse) size distribution, with particle sizes of up to 120 nm. Except for the inclusion of SiO₂ particles with a nonuniform size distribution, the ink was identical to that described in the previous example.

A coating was prepared on a glass substrate as described in the previous example. Reference is now made to FIG. 5B, which presents a schematic drawing of a coating comprising a single material such as SiO₂ with a nonuniform size distribution, e.g. small particles having diameters up to 30 nm (510) and large particles having diameters larger than 50 nm (511).

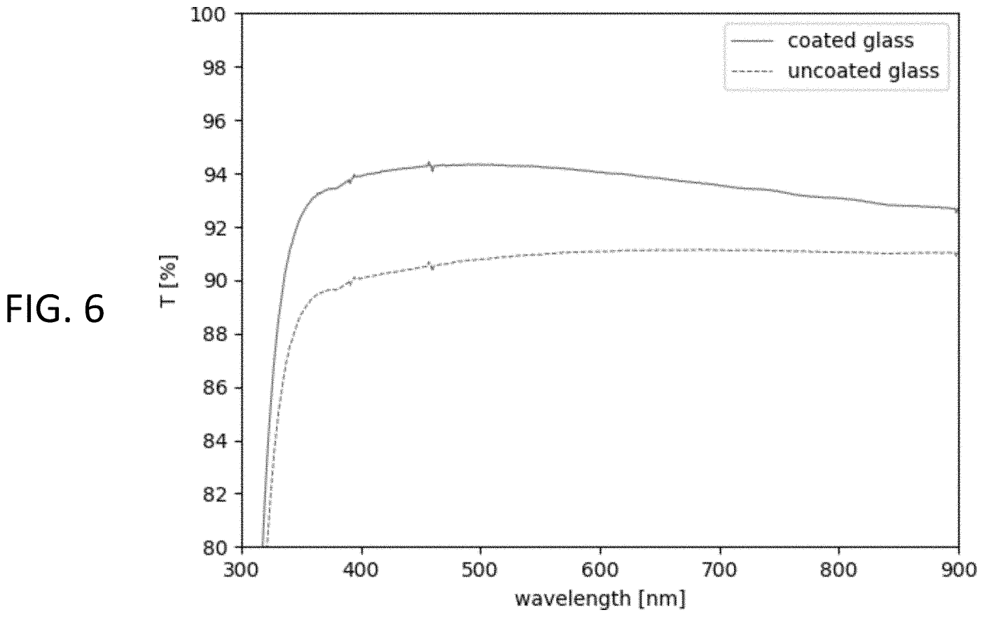

Reference is now made to FIG. 6, which demonstrates the AR properties of this coating. Shown in the figure are transmittance spectra of a glass slide without coating (dashed line) and a glass slide coated on one side with the SiO₂ coating described in this example (solid line). As can be seen from the spectra, the coated glass has a greater transmittance than the uncoated glass over the entire spectral range.

### Example 3

### Solution-Dispersion Ink for Deposition of an Anti-Soiling, Photocatalytic, and AR Mesoporous TiO₂/SiO₂ Coating and Coating Produced Therefrom

An ink was prepared that comprised a dispersion of nanoparticles of SiO₂ and TiO₂ in which TiO₂ comprised less than 5% by volume of the solids. The total solid content of the ink was 1 wt %, and the remaining components of the ink were as described in the preceding examples. The volume fraction of the TiO₂ was kept sufficiently low so that the AR properties of the coating would not be affected adversely. Reference is now made to FIG. 5C, which presents a schematic illustration of this coating, in which the two substances (510 and 511) comprise particles having similar and uniform sizes. Reference is now made to FIG. 5D, which presents a schematic illustration of a coating comprising SiO₂ and TiO₂ in which the two materials have nonuniform size distributions: small and large SiO₂ particles (510 and 511, respectively) and small and large TiO₂ particles (512 and 513, respectively).

### Example 4

### Water-Based Solution-Dispersion Inks with a Silicate Precursor and Multi-Functional Coating Produced Therefrom

The following method was used to produce a multiple-component solution-dispersion ink to produce multi-functional coatings.

A water-based solution-dispersion ink was prepared. The ink comprised an aqueous dispersion comprising nanoparticles of SiO₂ (0.9 wt %), TiO₂ (0.04 wt %), and Ag (0.01 wt %). In addition, the dispersion comprised nanoparticles of two additional substances A and B; in different runs, substance A was either SnO₂ (0.05 wt %), F:SnO₂ (0.05 wt %), or Sb:SnO₂ (0.05 wt %), and substance B was either Al₂O₃ (0.09 wt %) or ZrO₂ (0.06 wt %). The ink further precursor dissolved in the water, the precursor consisting of 8 mM Na₂SiO₃, 2 mM Na₂B₄O₇, and 2 mM Mg(OAc)₂. The solution-dispersion ink also contained 0.1-10 mM PEG and 1-10 mM TPE in solution in the water.

The SiO₂ and TiO₂ nanoparticles had a Gaussian size distribution with average diameter of 15 nm and σ=10 nm. The Ag nanoparticles had a broad size distribution with d₅₀=70 nm and d₉₀=110 nm, respectively; the SnO₂, F:SnO₂, or Sb:SnO₂ nanoparticles had diameters of 15-100 nm; and the Al₂O₃ or ZrO₂ nanoparticles had diameters of 5-100 nm diameter.

The final coating was characterized as having a porosity of 30-55%, depending on the temperature profile of the tempering step. The composition of the coating was analyzed and the composition was found to be:
70% SiO₂
5% TiO₂
3% Ag₂O₁₋ₓ, (0.5≤x≤0.9, depending on the temperature of the heating step)
10% SnO₂, F:SnO₂, or Sb:SnO₂
10% Al₂O₃ or ZrO₂
2% Na₂SiO₃, MgO, Na₂B₄O₇

All percentages are volume percentages relative to the total amount of solid material, i.e. excluding the volume of the pores.

Reference is now made to FIG. 7, which shows the anti-soiling effect of this coating in a comparison in sunlight of a non-coated glass (left side) with a glass that has been coated with the coating described in this example (right side). The hazy appearance of the uncoated glass is due to dust particles that are scattering the sunlight, while the coated glass shows much less scattering.

### Example 5

### Two-Layer Coating from Two Different Materials

In order to produce a two-layer coating, two inks were prepared. Ink #1 comprised a dispersion comprising 0.8 wt % nanoparticles of SiO₂ and 0.17 wt % nanoparticles of a material selected from SnO₂, F:SnO₂, and Sb:SnO₂; a precursor in solution in the carrier liquid as in the preceding example; PEG in solution in the carrier liquid (0.1-10 mM in various runs); and TPE in solution in the carrier liquid (1-10 mM in various runs).

The coating layer produced from ink #1 was analyzed as described in the previous example, and the composition of the solid determined to be (volume percentages excluding pores, as above):
63% SiO₂
35% SnO₂ or F:SnO₂
2% Na₂SiO₃, MgO, Na₂B₄O₇
   Ink #2 comprised a dispersion of nanoparticles comprising 0.9 wt % SiO₂, 0.08 wt % TiO₂, and 0.1 wt % of a material selected from ZrO₂ and Al₂O₃; a precursor in solution in the carrier liquid; 0.1-10 mM PEG in solution in the carrier liquid; and 1-10 mM TPE in solution in the carrier liquid. The size distribution of the nanoparticles was as defined in the previous example. The precursor comprised Na₂SiO₃ (1-20 mM in various runs); Na₂B₄O₇ (0.5-5 mM in various runs); Mg(OAc)₂ (0.5-5 mM in various runs); and ≤5 mM Ni(NO₃)₂.

The coating layer produced from ink #2 was analyzed as described in the previous example, and the composition of the solid determined to be (volume percentages excluding pores, as above):
70% SiO₂
10% TiO₂
17.5% ZrO₂ or Al₂O₃
2% Na₂SiO₃, MgO, Na₂B₄O₇
0.5% NiO

Ink #1 was deposited onto the glass and then dried. Ink #2 was then deposited on top of the dried layer of ink #1.

1.-50. (canceled)

51. A mesoporous nanostructured coating, comprising:
at least one layer of particles of at least one refractory material;
at least one second material;
at least a portion of said particles bound or interconnected one to another by said second material; and,
said second material being a product of a reaction of a precursor material, said reaction occurring with or subsequent to deposition of said particles;
wherein said mesoporous nanostructured coating is characterized by a characteristic selected from the group consisting of:
said mesoporous nanostructured coating is characterized by a single layer comprising a plurality of compositions, said compositions disposed according to a predetermined two-dimensional pattern in which said pattern comprises areas of different compositions;
said mesoporous nanostructured coating is characterized as comprising a plurality of layers of different compositions, said plurality of layers comprising a lower layer comprising particles of an electron-accepting material and an upper layer comprising particles of a hole-accepting material; and,
said mesoporous nanostructured coating is characterized as comprising a plurality of layers of different compositions, said plurality of layers comprising a bottom layer in the form of lines of coating material separated from one another, and at least one additional layer in the form of lines of coating material separated from one another, each of said lines comprising each of said at least one additional layer lying atop a line of coating material of a layer below it.

52. The mesoporous nanostructured coating according to claim 51, wherein said refractory material is selected from the group consisting of SiO₂, TiO₂, SnO₂, F:SnO₂, Sb:SnO₂, ZrO₂, Al₂O₃, NiO, Ag, Au, Mg, Ti, Al, Mn, and combinations thereof.

53. The mesoporous nanostructured coating according to claim 51, wherein said precursor material is selected from the group consisting of metasilicate salts, borate salts, Mg(OAc)₂, Ni(NO₃)₃, and combinations thereof.

54. The mesoporous nanostructured coating according to claim 51, wherein said coating is characterized by a porosity of 30-55%.

55. The mesoporous nanostructured coating according to claim 51, wherein said coating is characterized by a characteristic selected from the group consisting of:
said coating comprises articles of a material that generates electron-hole pairs upon irradiation by visible or UV light interconnected with particles of an electron-accepting material; and,
said coating is made of a material that produces a positive surface charge upon irradiation by visible or UV light.

56. The mesoporous nanostructured coating according to claim 51, wherein said coating is either super-hydrophobic or hydrophilic.

57. The mesoporous nanostructured coating according to claim 51, wherein said coating is characterized by a single layer comprising a plurality of compositions, said compositions disposed according to a predetermined two-dimensional pattern in which said pattern comprises areas of different compositions, and said predetermined two-dimensional pattern is selected from the group consisting of:
a checkerboard pattern; and,
lines of coating material separated one from another.

58. The mesoporous nanostructured coating according to claim 51, wherein:
said coating is characterized as comprising a plurality of layers of different compositions, said plurality of layers comprising a lower layer comprising particles of an electron-accepting material and an upper layer comprising particles of a hole-accepting material; and,
at least one of said layers comprises a material that produces electron-hole pairs upon irradiation by visible or UV light.

59. The mesoporous nanostructured coating according to claim 51, wherein said coating is characterized by a composition selected from the group consisting of:
(a) 70-74% SiO₂, 5%-15% TiO₂, 10% of a material selected from the group consisting of SnO₂, F:SnO₂, Sb:SnO₂, and combinations thereof, 10% of a material selected from the group consisting of Al₂O₃, ZrO₂, and combinations thereof, 1-5% of a material selected from the group consisting of Na₂SiO₃, MgO, Na₂B₄O₇, and combinations thereof, and ≤2% NiO;
(b) a first layer comprising 60-69% SiO₂, 30-39% of a material selected from the group consisting of SnO₂, F:SnO₂, and combinations thereof, and 1-5% of a material selected from the group consisting of Na₂SiO₃, MgO, Na₂B₄O₇, and combinations thereof; and a second layer comprising 60-69% SiO₂, 5-15% TiO₂, 10-30% of a material selected from the group consisting of ZrO₂ and Al₂O₃, 1-5% of a material selected from the group consisting of Na₂SiO₃, MgO, Na₂B₄O₇, and combinations thereof, and ≤2% NiO; and,
(c) 70% SiO₂, 5% TiO₂, 3% Ag₂O₁₋ₓ (0.1≤x≤0.9), 10% of a material selected from the group consisting of SnO₂, F:SnO₂, Sb:SnO₂, and combinations thereof, 10% of a material selected from the group consisting of Al₂O₃, ZrO₂, and combinations thereof, and 2% of a material selected from the group consisting Na₂SiO₃, MgO, Na₂B₄O₇;
and all percentages are percent by volume of solid material, excluding voids.

60. A method for preparing a mesoporous nanostructured coating on a substrate (1), said method comprising:
preparing a coating liquid comprising:
a carrier liquid; and,
at least one material selected from the group consisting of particles of coating material, precursors of coating material, and dispersants;
depositing said coating liquid onto said substrate;
drying said coating liquid subsequent to said step of depositing; and,
heating said coating liquid subsequent to said step of depositing;
wherein said step of depositing said coating liquid onto said substrate is characterized by a characteristic selected from the group consisting of:
(a) said step of depositing said coating liquid on said substrate comprises:
depositing a first coating liquid on said substrate in a first predetermined pattern;
adding, for each additional coating liquid to be used, at least one additional print unit (31) comprising at least one additional print unit print head (30);
introducing at least one additional coating liquid into each said additional print unit print head; and,
depositing said at least one additional coating liquid onto said substrate in an additional predetermined pattern;
(b) said step of depositing said coating liquid on said substrate comprises:
depositing a first coating liquid on said substrate in a first predetermined pattern;
adding, for each additional coating liquid to be used, at least one additional print unit (31) comprising at least one additional print unit print head (30); introducing at least one additional coating liquid into each said additional print unit print head; and,
depositing said at least one additional coating liquid onto said substrate in a second predetermined pattern;
said first predetermined pattern and said second predetermined pattern together forming a checkerboard pattern;
(c) said step of depositing said coating liquid on said substrate comprises depositing multiple layers of coating liquid, one atop another, and said multiple layers comprise:
a first layer (310) comprising transparent conductive electron-accepting material;
a plurality of semiconductor layers (311, 312) comprising wide-band semiconductors, at least one of which absorbs light in at least a portion of the solar spectrum, deposited sequentially atop said first layer; and,
a top layer (313) comprising transparent hole-accepting material, deposited atop said plurality of semiconductor layers;
(d) said step of depositing said coating liquid on said substrate comprises depositing multiple layers of coating liquid, one atop another, and said step of preparing a coating liquid comprises:
preparing a first coating liquid comprising particles of SiO₂; particles of at least one material selected from the group consisting of SnO₂, F:SnO₂, and Sb:SnO₂; at least one first material in solution selected from the group consisting of 1-20 mM Na₂SiO₃, 0.5-5 mM Na₂B₄O₇, 0.5-5 mM Mg(OAc)₂, and, at least one second material in solution selected from the group consisting of 0.1-10 mM PEG and 1-10 mM TPE; and,
preparing a second coating liquid comprising particles of SiO₂; particles of TiO₂; at least one material selected from the group consisting of ZrO₂ and Al₂O₃; at least one third material in solution selected from the group consisting of 1-20 mM Na₂SiO₃, 0.5-5 mM Na₂B₄O₇, 0.5-5 mM Mg(OAc)₂, and, at least one fourth material in solution selected from the group consisting of 0.1-10 mM PEG and 1-10 mM TPE; and,
said step of depositing said coating liquid onto said substrate in a first predetermined pattern comprises:
depositing said first coating liquid on said substrate in a first predetermined pattern;
drying said first coating liquid;
depositing said second coating liquid on said substrate in a second predetermined pattern; and,
drying said second coating liquid; and,
(e) said step of depositing said coating liquid on said substrate comprises depositing multiple layers of coating liquid, one atop another, and said step of preparing a coating liquid comprises:
preparing a first coating liquid comprising particles of SiO₂; particles of SnO₂; at least one first material in solution selected from the group consisting of 1-20 mM Na₂SiO₃, 0.5-5 mM Na₂B₄O₇, 0.5-5 mM Mg(OAc)₂, and, at least one second material in solution selected from the group consisting of 0.1-10 mM PEG and 1-10 mM TPE;
preparing a second coating liquid comprising particles of SiO₂; particles of TiO₂; at least one third material in solution selected from the group consisting of 1-20 mM Na₂SiO₃, 0.5-5 mM Na₂B₄O₇, 0.5-5 mM Mg(OAc)₂, and, at least one fourth material in solution selected from the group consisting of 0.1-10 mM PEG and 1-10 mM TPE; and,
preparing a third coating liquid comprising dispersed NiO particles; 1-50 mM dissolved Ni(NO₃)₂; and, at least one fifth material in solution selected from the group consisting of 0.1-10 mM PEG and 1-10 mM TPE; and,
said step of depositing said coating liquid onto said substrate in a first predetermined pattern comprises:
depositing onto said substrate a transparent conductive oxide (TCO) layer characterized by a sheet resistance <100 Ω/square;
depositing said first coating liquid onto said substrate, thereby forming a second layer;
drying said second layer;
depositing said second coating liquid onto said substrate, thereby forming a third layer;
drying said third layer; and,
depositing said third coating liquid onto said substrate, thereby forming a fourth layer.

61. The method according to claim 60, wherein:
said step of preparing a coating liquid comprises preparing a coating liquid comprising a suspension and/or dispersion of at least one coating material selected from the group consisting of microparticles, sub-micron particles, and nanoparticles;
said suspension and/or dispersion comprises particles of more than one material; and,
each material has a different particle size and/or distribution.

62. The method according to claim 60, wherein said step of preparing a coating liquid comprises preparing a coating liquid selected from the group consisting of:
coating liquids comprising a suspension and/or dispersion of at least one coating material selected from the group consisting of SiO₂, TiO₂, ZrO₂, SnO₂, F:SnO₂, and Fe₂O₃; and,
coating liquids comprising a suspension and/or dispersion of at least one coating material selected from the group consisting of SiO₂, TiO₂, ZrO₂, SnO₂, F:SnO₂, and Fe₂O₃, and at least one material selected from the group consisting of Ag, Au, Mg, Ti, Al and Mn.

63. The method according to claim 60, wherein said step of preparing a coating liquid comprises preparing a coating liquid comprising a coating material or precursor thereof that has photocatalytic activity.

64. The method according to claim 60, wherein said step of preparing a coating liquid comprises preparing a coating liquid selected from the group consisting of:
a coating liquid comprising a suspension or dispersion comprising particles of SiO₂ and TiO₂ in a volume ratio SiO₂:TiO₂ of at least 95:5;
a coating liquid comprising a dissolved Ti-containing precursor and suspended or dispersed SiO₂ spheres, wherein said SiO₂ spheres are characterized diameters of 4-500 nm;
a coating liquid comprising particles of SiO₂ and Ag in a volume ratio SiO₂:Ag of at least 95:5; and,
a coating liquid comprising particles of SiO₂; particles of TiO₂; particles of Ag; particles of at least one substance selected from the group consisting of SnO₂, F:SnO₂, and Sb:SnO₂; particles of at least one substance selected from the group consisting of Al₂O₃ and ZrO₂; and, at least one material in solution, said at least one material in solution selected from the group consisting of Na₂SiO₃, Na₂B₄O₇, Mg(OAc)₂, Ni(NO₃)₃, PEG, and TPE.

65. The method according to claim 60, wherein step of depositing said coating liquid on said substrate comprises:
introducing said coating liquid into a first print unit (23), said first print unit comprising least one print head (21), said print head comprising at least one printing nozzle (20);
placing said inkjet printer at a predetermined distance from said substrate;
moving said substrate (1) with a velocity vₓ relative to said at least one printing nozzle; and,
depositing droplets of said coating liquid in said first predetermined pattern and with a predetermined spacing from said at least one print head onto said substrate via said at least one printing nozzle.

66. The method according to claim 65, wherein said first print unit comprises at least one additional print head (22) offset in a y direction from said at least one print head (21).

67. The method according to claim 60, wherein said step of depositing said coating liquid on said substrate comprises depositing multiple layers of coating liquid, one atop another, and said method comprises drying each layer prior to deposition of a subsequent layer.

68. The method according to claim 60, wherein said method comprises depositing a TCO layer and said step of depositing a TCO layer comprises a step selected from the group consisting of:
depositing a commercially-available TCO layer on said substrate; and,
preparing a fourth coating liquid comprising (a) particles of SiO₂; (b) particles of doped SnO₂; (c) at least one sixth material in solution selected from the group consisting of 1-20 mM metasilicate salt, 0.5-5 mM borate salt, 0.5-5 mM Mg(OAc)₂; and (d) at least one seventh material in solution selected from the group consisting of 0.1-10 mM PEG and 1-10 mM TPE; and, depositing said fourth coating liquid onto said substrate, thereby forming a TCO layer.

69. The method according to claim 60, wherein said step of depositing said coating liquid on said substrate comprises depositing multiple layers of coating liquid, one atop another, and said method comprises depositing a plurality of n coating liquids on said substrate, wherein said step of depositing said coating liquid comprises:
depositing each of said coating liquids so as to partially cover said substrate;
depositing each of said coating liquids 1 through n−1 such that each coating liquid is separated from each of the other coating liquids; and,
depositing coating liquid n so as to create an electrical connection between coating liquids 1 through n−1.

70. The method according to claim 60, wherein said step of heating said coating liquid comprises at least one step selected from the group consisting of:
heating said coating liquid until said particles of said coating material sinter to a predetermined degree;
heating said coating liquid comprises heating until said precursor undergoes a chemical reaction;
heating until said precursor oxidizes and binds together particles of coating material;
heating with a heating profile like that used to anneal glass; and,
heating to a maximum temperature of between 630° C. and 680° C.
